(19) United States
(12) Patent Application Publication
(10) Pub. No.: US 2010/0201315 A1
(43) Pub. Date: Aug. 12, 2010

(54) ELECTRONIC DEVICE, CHARGER, AND CHARGING DEVICE

(75) Inventors: Masanori Oshimi, Yokohama-shi (JP); Hirohiko Yoshida, Yokohama-shi (JP); Norihito Mochida, Yokohama-shi (JP); Junichi Yasuno, Yokohama-shi (JP); Akihiko Sekiguchi, Yokohama-shi (JP); Hidehiko Yamada, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/678,996

(22) PCT Filed: Sep. 26, 2008
(86) PCT No.: PCT/JP2008/002684

§ 371 Date: Mar. 18, 2010

(30) Foreign Application Priority Data
Sep. 27, 2007 (JP) 2007-252364
Sep. 27, 2007 (JP) 2007-252365

(51) Int. Cl. H02J 7/00

(52) U.S. Cl. 320/108

(57) ABSTRACT

There is provided an electronic device for enabling the user to recognize the relative position of the electronic device to a power supply device such as a charger. An electronic device 11B includes a main coil 18 having a conductor wire wound around a main point 33 for receiving power for charging a secondary battery from a charger 12, a position detection coil 31 placed at a first point in the electronic device 11B, a position detection coil 32 placed at a second point in the electronic device 11B, and a position shift display section 39. If magnetic flux density detected by the position detection coil 31 is higher than magnetic flux density detected by the position detection coil 32, the position shift display section 39 provides notification of prompting the user to move the electronic device 11B from the second point to the first point, and if the magnetic flux density detected by the position detection coil 32 is higher than the magnetic flux density detected by the position detection coil 31, the position shift display section 39 provides notification of prompting the user to move the electronic device 11B from the first point to the second point.

### TECHNICAL FIELD

The present invention relates to an electronic device, a charger, and a charging system, and in particular to an electronic device, a charger, and a charging system for making it possible to recognize a relative position of the electronic device with respect to a power supply device such as a charger.

### BACKGROUND ART

In recent years, it has been made possible for a power supply device such as a charger for supplying power to supply power without electric contact with a device to which power is supplied (in a non-contact manner)

As an example of such a power supply device, a charger for charging by causing an external AC magnetic field to act on an electronic device having an electromagnetic induction coil is known; the charger is an electromagnetic induction charger including a charger section connected to a commercial power supply and having a stabilization power supply circuit and a drive circuit for outputting an AC signal for charging, a primary coil section provided separately from the charger section, connected to the drive circuit, and having a primary coil to generate an AC magnetic field for charging upon reception of an AC signal, and a mark section provided in the primary coil section for displaying the position and directivity of the primary coil corresponding to the position of the induction coil of the electronic device (For example, refer to Patent Document 1).

As an example of another power supply device, a cooking device is known; the cooking device has a magnetism generation section, a load section including a secondary coil placed on a placement top in the magnetism generation section, positioning means for determining the placement position of the load section, and load type notification means for notifying the magnetism generation section of the type of load in the load section before transmission of a high frequency current to the secondary coil, wherein the magnetism generation section includes a primary coil placed below the placement top, oscillation means for allowing a high frequency current to flow into the primary coil, and control means for controlling oscillation output of the oscillation means based on the notification description from the load type notification means and the load section supplies power based on the high frequency current electromagnetically coupled with the primary coil and transmitted to the secondary coil to the load (For example, refer to Patent Document 2).

Patent Document 1: Japanese Utility Model Registration No. 2524306

Patent Document 2: Japanese Patent No. 3871729

### DISCLOSURE OF THE INVENTION

### Problems to be Solved by the Invention

When a power supply device supplies power to an external electronic device in a non-contact manner, unless the power supply device and the electronic device are placed so that both become a predetermined positional relationship (for example, the electronic device is placed just above the center of the power supply device or the like), for example, the magnetic flux density to receive power in the electronic device becomes loose and thus the power transmission efficiency lowers. Particularly, if the power supply device does not include a mechanism for placing an electronic device at a predetermined position relative to the power supply device, the possibility that the power transmission efficiency may lower becomes high.

In view of the circumstances described above, it is an object of the present invention to provide an electronic device and a charging system for enabling the user to recognize the relative position of the electronic device to a power supply device.

It is also an object of the present invention to provide a charger and a charging system for enabling the user to recognize the relative position of an electronic device to the charger of an example of a power supply device.

### Means for Solving the Problems

In order to achieve the above object, a first electronic device according to the present invention is configured by an electronic device using a secondary battery that can be charged by a charger for charging in a non-contact manner as a power supply, the electronic device comprising: a main coil having a conductor wire wound around a main point for receiving power for charging the secondary battery from the charger; a first magnetism detection section placed at a first point in the electronic device; a second magnetism detection section placed at a second point in the electronic device, the second point positioned symmetrically with respect to the first point about the main point; and a notification section, wherein if magnetic flux density detected by the first magnetism detection section is higher than magnetic flux density detected by the second magnetism detection section, the notification section provides notification of prompting a user to move the electronic device from the second point to the first point, and if the magnetic flux density detected by the second magnetism detection section is higher than the magnetic flux density detected by the first magnetism detection section, the notification section provides notification of prompting the user to move the electronic device from the first point to the second point.

According to the configuration described above, the user can recognize the relative position of the electronic device with respect to the charger of an example of a power supply device. The user can be notified which direction and how much the electronic device shifts in from the optimum position relative to the charger for charging the electronic device and can be prompted to place the electronic device at the optimum position. The electronic device is placed at the optimum position, whereby it is made possible to charge in good power transmission efficiency.

A second electronic device according to the present invention is configured in that the first magnetism detection section is a first coil having a conductor wire wound in a predetermined number of turns in a predetermined shape around the first point, the second magnetism detection section is a second coil having a conductor wire wound in the predetermined number of turns in the predetermined shape around the second point,

if electromotive voltage of the first coil is larger than electromotive voltage of the second coil, the notification section provides notification of prompting the user to move the electronic device from the second coil to the first coil, and
if the electromotive voltage of the second coil is larger than the electromotive voltage of the first coil, the notification section provides notification of prompting the user to move the electronic device from the first coil to the second coil.

According to the configuration described above, the user can recognize the relative position of the electronic device with respect to the charger of an example of a power supply device. The user can be notified which direction and how much the electronic device shifts in from the optimum position relative to the charger for charging the electronic device and can be prompted to place the electronic device at the optimum position. The electronic device is placed at the optimum position, whereby it is made possible to charge in good power transmission efficiency.

A third electronic device according to the present invention is configured by further comprising: a third coil having a conductor wire wound in the predetermined number of turns in the predetermined shape around a third point; and a fourth coil having a conductor wire wound in the predetermined number of turns in the predetermined shape around a fourth point, wherein the third point and the fourth point are symmetric with each other about the main point, if electromotive voltage of the third coil is larger than electromotive voltage of the fourth coil, the notification section provides notification of prompting the user to move the electronic device from the fourth coil to the third coil, if the electromotive voltage of the fourth coil is larger than the electromotive voltage of the third coil, the notification section provides notification of prompting the user to move the electronic device from the third coil to the fourth coil, and a straight line connecting the first point and the second point and a straight line connecting the third point and the fourth point cross at a predetermined angle.

According to the configuration described above, it is made possible to detect a position shift in four directions (for example, up and down and right and left) and it is made possible to notify the user of the optimum position of the electronic device relative to the charger more precisely.

A fourth electronic device according to the present invention is configured in that the predetermined angle is substantially 90 degrees.

According to the configuration described above, coils can be placed with the same spacing in four directions (for example, up and down and right and left) and it is made possible to detect a position shift with the same accuracy in any direction.

A fifth electronic device according to the present invention is configured in that a high voltage end of the first coil is connected to a high voltage end of the second coil, and a low voltage end of the first coil is connected to a low voltage end of the second coil, whereby a loop circuit is formed, if the electromotive voltage of the first coil is equal to the electromotive voltage of the second coil, no current flows into the loop circuit, and if the electromotive voltage of the first coil differs from the electromotive voltage of the second coil, a current flows into the loop circuit, and the notification section provides the notification of prompting in response to the presence or absence and a direction of the current flowing into the loop circuit.

According to the configuration described above, for example, if the placement position of the electronic device relative to the charger shifts in the up and down direction or the left-right direction, a current flows into the loop circuit, so that a position shift can be detected. If the placement position of the electronic device relative to the charger is the optimum position, no current flows into the loop circuit, so that the user can recognize the optimum position and power consumption of the electronic device can be decreased.

A sixth electronic device according to the present invention is configured in that the notification section includes a plurality of illuminants, and provides the notification of prompting the user to move the electronic device according to a light emission pattern of the plurality of illuminants.

According to the configuration described above, notification of prompting the user to move the electronic device is provided according to the light emission pattern of the illuminants, so that the user can easily recognize which direction and how much the electronic device shifts in from the normal position.

A seventh electronic device according to the present invention is configured in that the main coil includes a flat coil placed along a predetermined plane, and the plurality of magnetism detection sections are placed along the predetermined plane.

According to the configuration described above, the main coil and the coils for performing magnetism detection are placed on the predetermined same plane, so that the electronic device can be slimmed down.

A first charging system according to the present invention is configured by a charging system comprising: a charger for charging in a non-contact manner; and an electronic device using a secondary battery that can be charged by the charger as a power supply, wherein the electronic device comprises: a main coil having a conductor wire wound around a main point for receiving power for charging the secondary battery from the charger; a first magnetism detection section placed at a first point in the electronic device; a second magnetism detection section placed at a second point in the electronic device, the second point positioned symmetrically with respect to the first point about the main point; and a notification section, wherein if magnetic flux density detected by the first magnetism detection section is higher than magnetic flux density detected by the second magnetism detection section, the notification section provides notification of prompting a user to move the electronic device from the second point to the first point, and if the magnetic flux density detected by the second magnetism detection section is higher than the magnetic flux density detected by the first magnetism detection section, the notification section provides notification of prompting the user to move the electronic device from the first point to the second point.

According to the configuration described above, the user can recognize the relative position of the electronic device with respect to the charger of an example of a power supply device. The user can be notified which direction and how much the electronic device shifts in from the optimum position relative to the charger for charging the electronic device and can be prompted to place the electronic device at the optimum position. The electronic device is placed at the optimum position, whereby it is made possible to charge in good power transmission efficiency.

Further, in order to achieve the above object, a first charger according to the present invention is configured by a charger for charging a chargeable secondary battery used as a power supply of an electronic device in a non-contact manner, the charger comprising: a main coil having a conductor wire wound around a main point for sending power for charging the secondary battery; a first magnetism detection section placed at a first point in the charger; a second magnetism detection section placed at a second point in the charger, the second point positioned symmetrically with respect to the first point about the main point; and a notification section, wherein if magnetic flux density detected by the first magnetism detection section is higher than magnetic flux density detected by the second magnetism detection section, the notification section provides notification of prompting a user to move the electronic device from the second point to the first point and if the magnetic flux density detected by the second magnetism detection section is higher than the magnetic flux density detected by the first magnetism detection section, the notification section provides notification of prompting the user to move the electronic device from the first point to the second point.

According to the configuration described above, the user can recognize the relative position of the electronic device with respect to the charger of an example of a power supply device. The user can be notified which direction and how much the electronic device shifts in from the optimum position relative to the charger for charging the electronic device and can be prompted to place the electronic device at the optimum position. The electronic device is placed at the optimum position, whereby it is made possible to charge in good power transmission efficiency.

A second charger according to the present invention is configured in that the first magnetism detection section is a first coil having a conductor wire wound in a predetermined number of turns in a predetermined shape around the first point, the second magnetism detection section is a second coil having a conductor wire wound in the predetermined number of turns in the predetermined shape around the second point, if electromotive voltage of the first coil is larger than electromotive voltage of the second coil, the notification section provides notification of prompting the user to move the electronic device from the second coil to the first coil, and wherein if the electromotive voltage of the second coil is larger than the electromotive voltage of the first coil, the notification section provides notification of prompting the user to move the electronic device from the first coil to the second coil.

According to the configuration described above, the user can recognize the relative position of the electronic device with respect to the charger of an example of a power supply device. The user can be notified which direction and how much the electronic device shifts in from the optimum position relative to the charger for charging the electronic device and can be prompted to place the electronic device at the optimum position. The electronic device is placed at the optimum position, whereby it is made possible to charge in good power transmission efficiency.

A third charger according to the present invention is configured by further comprising: a third coil having a conductor wire wound in the predetermined number of turns in the predetermined shape around a third point; and a fourth coil having a conductor wire wound in the predetermined number of turns in the predetermined shape around a fourth point, wherein the third point and the fourth point are symmetric with each other about the main point, if electromotive voltage of the third coil is larger than electromotive voltage of the fourth coil, the notification section provides notification of prompting the user to move the electronic device from the fourth coil to the third coil, wherein if the electromotive voltage of the fourth coil is larger than the electromotive voltage of the third coil, the notification section provides notification of prompting the user to move the electronic device from the third coil to the fourth coil, and a straight line connecting the first point and the second point and a straight line connecting the third point and the fourth point cross at a predetermined angle.

According to the configuration described above, it is made possible to detect a position shift in four directions (for example, up and down and right and left) and it is made possible to notify the user of the optimum position of the electronic device relative to the charger more precisely.

A fourth charger according to the present invention is configured in that the predetermined angle is substantially 90 degrees.

According to the configuration described above, coils can be placed with the same spacing in four directions (for example, up and down and right and left) and it is made possible to detect a position shift with the same accuracy in any direction.

A fifth charger according to the present invention is configured in that a high voltage end of the first coil is connected to a high voltage end of the second coil, and a low voltage end of the first coil is connected to a low voltage end of the second coil, whereby a loop circuit is formed, if the electromotive voltage of the first coil is equal to the electromotive voltage of the second coil, no current flows into the loop circuit, and if the electromotive voltage of the first coil differs from the electromotive voltage of the second coil differ, a current flows into the loop circuit, and the notification section provides the notification of prompting in response to the presence or absence and a direction of the current flowing into the loop circuit.

According to the configuration described above, for example, if the placement position of the electronic device relative to the charger shifts in the up and down direction or the left-right direction, a current flows into the loop circuit, so that a position shift can be detected. If the placement position of the electronic device relative to the charger is the optimum position, no current flows into the loop circuit, so that the user can recognize the optimum position and power consumption of the electronic device can be decreased.

A sixth charger according to the present invention is configured in that the notification section includes a plurality of illuminants and provides the notification of prompting the user to move the electronic device according to a light emission pattern of the plurality of illuminants.

According to the configuration described above, notification of prompting the user to move the electronic device is provided according to the light emission pattern of the illuminants, so that the user can easily recognize which direction and how much the electronic device shifts in from the normal position.

A seventh charger according to the present invention is configured in that the main coil includes a flat coil placed along a predetermined plane, and the plurality of magnetism detection sections are placed along the predetermined plane.

According to the configuration described above, the main coil and the coils for performing magnetism detection are placed on the predetermined same plane, so that the electronic device can be slimmed down.

A second charging system according to the present invention is configure by a charging system comprising: a charger for charging in a non-contact manner; and an electronic device using a secondary battery that can be charged by the charger as a power supply, wherein the charger comprises: a main coil having a conductor wire wound around a main point for sending power for charging the secondary battery; a first magnetism detection section placed at a first point in the charger; a second magnetism detection section placed at a second point in the electronic device, the second point positioned symmetrically with respect to the first point about the main point; and a notification section, wherein if magnetic flux density detected by the first magnetism detection section is higher than magnetic flux density detected by the second magnetism detection section, the notification section provides notification of prompting a user to move the electronic device from the second point to the first point and if the magnetic flux density detected by the second magnetism detection section is higher than the magnetic flux density detected by the first magnetism detection section, the notification section provides notification of prompting the user to move the electronic device from the first point to the second point.

According to the configuration described above, the user can recognize the relative position of the electronic device with respect to the charger of an example of a power supply device. The user can be notified which direction and how much the electronic device shifts in from the optimum position relative to the charger for charging the electronic device and can be prompted to place the electronic device at the optimum position. The electronic device is placed at the optimum position, whereby it is made possible to charge in good power transmission efficiency.

### ADVANTAGEOUS EFFECTS OF THE INVENTION

According to the present invention, the user can easily recognize the relative position of the electronic device to the power supply device. The user can also easily recognize the relative position of the electronic device to the charger.

### BRIEF DESCRIPTION OF THE DRAWINGS

FIG. 1 is a schematic view to show an example of a charging system according to a first embodiment of the present invention.

FIG. 2 describes supply of power according to a flow of a magnetic flux from a primary coil to a secondary coil according to the first embodiment of the present invention.

FIG. 3 shows an example of the configuration of an electronic device according to the first embodiment of the present invention.

FIG. 4 is a flowchart to describe an example of the operation of the electronic device according to the first embodiment of the present invention.

FIG. 5 is a graph to describe an example of change in feeding current of the electronic device in the first embodiment of the present invention.

FIG. 6 is a flowchart to describe another example of the operation of the electronic device according to the embodiment of the present invention.

FIG. 7 is a graph to describe an example of change in feeding current of the electronic device in the first embodiment of the present invention.

FIG. 8 is a perspective view of an example of the electronic device when a notification section performs display in the first embodiment of the present invention.

FIG. 9 shows a display example when the electronic device according to the first embodiment of the present invention has two illuminants as the notification section.

FIG. 10 shows a display example when the electronic device according to the first embodiment of the present invention has three illuminants as the notification section.

FIG. 11 is a perspective view of an example of the electronic device when the electronic device according to the first embodiment of the present invention has a position shift indicator as the notification section.

FIG. 12 is a perspective view of an example of the electronic device when the electronic device according to the first embodiment of the present invention has a two-color illuminant for emitting two colors of red and green.

In FIG. 13, (a) is a schematic view to show an example of a charging system according to a second embodiment of the present invention; and (b) shows an example of placement of a secondary coil and position detection coils of an electronic device according to the second embodiment of the present invention.

FIG. 14 shows an example of the positional relationship between the secondary coil of the electronic device and a primary coil of a charger in the second embodiment of the present invention.

In FIG. 15, (a) is a configuration diagram to show an example of the configuration of the electronic device according to the second embodiment of the present invention; (b) shows a placement example of position detection coils according to the second embodiment of the present invention; and (c) shows a placement example of the position detection coils according to the second embodiment of the present invention.

FIG. 16 shows an example of the detailed configuration to detect a position shift of the electronic device according to the second embodiment of the present invention.

FIG. 17 is a flowchart to show an example of the operation for the electronic device according to the second embodiment of the present invention to detect a position shift.

FIG. 18 is a perspective view of an example of the electronic device for a position shift display section to perform display according to the second embodiment of the present invention.

In FIG. 19, (a) shows an example of the configuration of an electronic device in a third embodiment of the present invention (to use 8-shaped coil); and (b) shows an example of the configuration of non-8-shaped coil in the third embodiment of the present invention.

FIG. 20 shows an example of the detailed configuration to detect a position shift of the electronic device in the third embodiment of the present invention.

FIG. 21 shows an example of a current flowing through a loop circuit when the position of the electronic device is appropriate in the third embodiment of the present invention.

FIG. 22 shows an example of a current flowing through the loop circuit when the position of the electronic device is not appropriate in the third embodiment of the present invention.

FIG. 23 is a flowchart to show an example of the operation for the electronic device to detect a position shift in the third embodiment of the present invention.

In FIG. 24, (a) is a schematic view to show an example of a charging system according to a fourth embodiment of the present invention; and (b) shows a placement example of a primary coil and position detection coils of a charger according to the fourth embodiment of the present invention.

FIG. 25 shows an example of the positional relationship between the primary coil of the charger and the secondary coil of an electronic device in the fourth embodiment of the present invention.

In FIG. 26, (a) is a configuration diagram to show an example of the configuration of the charger according to the fourth embodiment of the present invention; (b) shows a placement example of position detection coils according to the fourth embodiment of the present invention; and (c) shows a placement example of the position detection coils according to the fourth embodiment of the present invention.

FIG. 27 shows an example of the detailed configuration to detect a position shift of the charger according to the fourth embodiment of the present invention.

FIG. 28 is a flowchart to show an example of the operation for the charger according to the fourth embodiment of the present invention to detect a position shift.

FIG. 29 is a perspective view of an example of the charger for a position shift display section to perform display according to the fourth embodiment of the present invention.

In FIG. 30, (a) shows an example of the configuration of a charger in a fifth embodiment of the present invention (to use 8-shaped coil); and (b) shows an example of the configuration of non-8-shaped coil in the fifth embodiment of the present invention.

FIG. 31 shows an example of the detailed configuration to detect a position shift of the charger in the fifth embodiment of the present invention.

FIG. 32 shows an example of a current flowing through a loop circuit when the position of an electronic device is appropriate in the fifth embodiment of the present invention.

FIG. 33 shows an example of a current flowing through the loop circuit when the position of the electronic device is not appropriate in the fifth embodiment of the present invention.

FIG. 34 is a flowchart to show an example of the operation for the charger to detect a position shift in the fifth embodiment of the present invention.

FIG. 35 shows an example of measurement values of a magnetic field strength distribution for the charger to charge the electronic device in the fourth and fifth embodiments of the present invention.

### DESCRIPTION OF REFERENCE NUMERALS

100, 100B, 100C, 100D, 100E Charging system
11, 11B, 11C Electronic device
12, 12B, 12C Charger
13 Notification section
15 Power transmission circuit
16 Primary coil
17 Magnetic flux
18 Secondary coil
19 Power passive circuit
21 Current detection section
22 Dummy load
23 Switch
24 Power supply
26 Red/green two-color illuminant
27 First illuminant
28 Second illuminant
29 Third illuminant
30 Position shift indicator
31, 32, 33, 34, 51, 52, 53, 54 Power detection coil
31a, 32a, 33a, 34a, 51a, 52a, 53a, 54a Illuminant
33, 53 Main point
38, 38B, 138, 138B Position shift detection section
39, 139 Position shift display section
40 Power supply section
41 Load
45, 145 Loop circuit
47, 147 Current detection circuit
47A, 147A X axis current detection circuit
48B, 148B Y axis current detection circuit
49, 71, 149, 171 Position determination circuit
60 Control unit
61 AC adapter
65, 66, 68, 69, 165, 166, 168, 169 Rectification section
67, 70, 167, 170 Comparison section

### BEST MODE FOR CARRYING OUT THE INVENTION

Electronic devices, chargers, and charging systems in embodiments of the present invention will be described below with reference to the accompanying drawings:

Electronic devices according to the embodiments of the present invention are a mobile terminal, a digital camera, and other electronic devices using a secondary battery that can be charged by a charger for charging in a non-contact manner, for example. A charger for charging the secondary battery of an electronic device is an example of a power supply device. The expression “charging in a non-contact manner” means charging without using an electric contact between the electronic device and the charger.

### First Embodiment

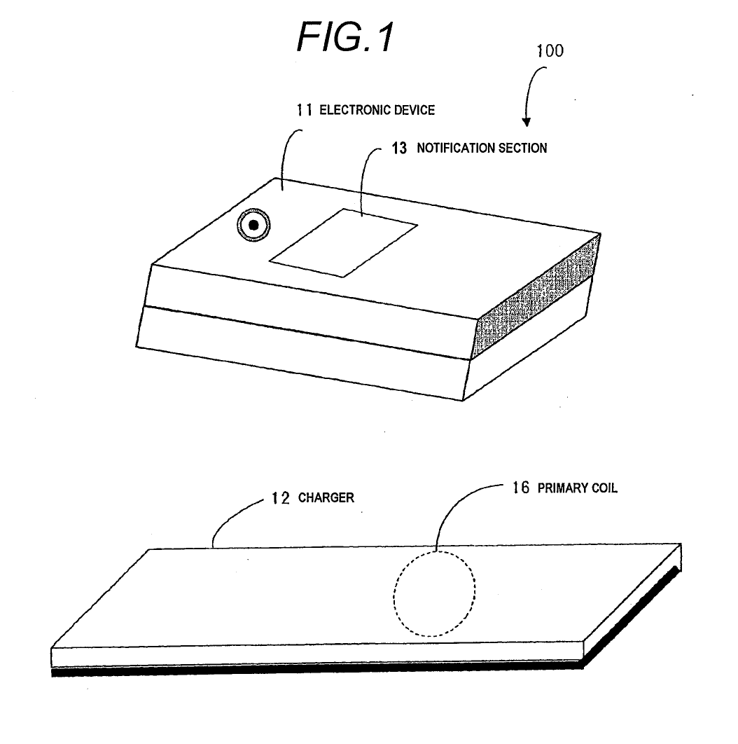

FIG. 1 is a schematic view to show an example of a charging system 100 according to a first embodiment of the present invention. The charging system 100 has an electronic device 11 and a charger 12.

The electronic device 11 has a notification section 13 for detecting the magnitude of a feeding current to a secondary battery and notifying the user of a position shift of the charger 12; for example, the electronic device 11 detects a position shift between a primary coil contained in the charger 12 and a secondary coil contained in the electronic device 11 by monitoring the supply current to the secondary battery and notifies the user of the position shift.

That is, when power is supplied from the charger 12, the electronic device 11 determines the position shift degree between the primary coil and the secondary coil according to the magnitude of the current flowing into a dummy load at the secondary side. If the shift exists, the electronic device 11 notifies the user of the shift with a display, etc., forming the notification section 13. The electronic device 11 wherein the secondary coil is placed detects the position shift degree, whereby the notification section 13 for performing display, etc., of the electronic device 11 can be used to easily notify the user of the position shift degree.

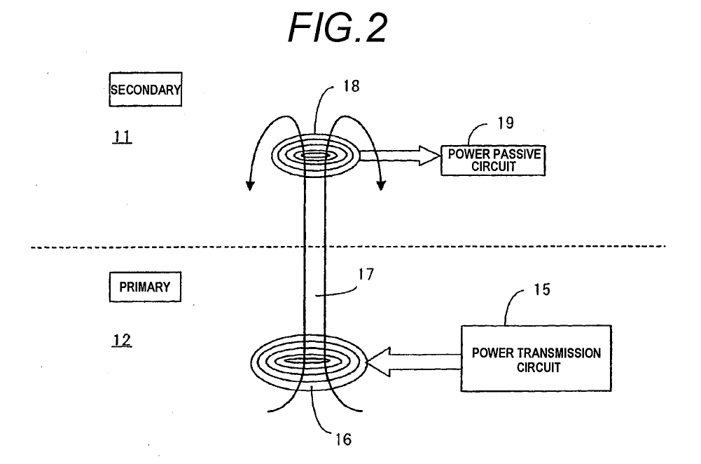

FIG. 2 describes supply of power according to a flow of a magnetic flux 17 from a primary coil 16 provided in the charger 12 to a secondary coil 18 provided in the electronic device 11.

As shown in FIG. 2, the electronic device 11 uses a secondary battery that can be charged by the charger 12 in a non-contact manner as a power supply, and includes the secondary coil 18 for receiving power of charging the secondary battery from the charger 12 through the magnetic flux 17 and a power passive circuit 19 for receiving power from the secondary coil 18 and supplying power to sections of the device. On the other hand, the charger 12 includes a power transmission circuit 15 for transmitting power supplied to the secondary battery of the electronic device 11 and the primary coil 16 for transmitting power to the secondary coil 18 of the electronic device 11 through the magnetic flux 17. In charging systems 100B to 100E described later, non-contact power supply and non-contact charging are also realized according to the configuration shown in FIG. 2.

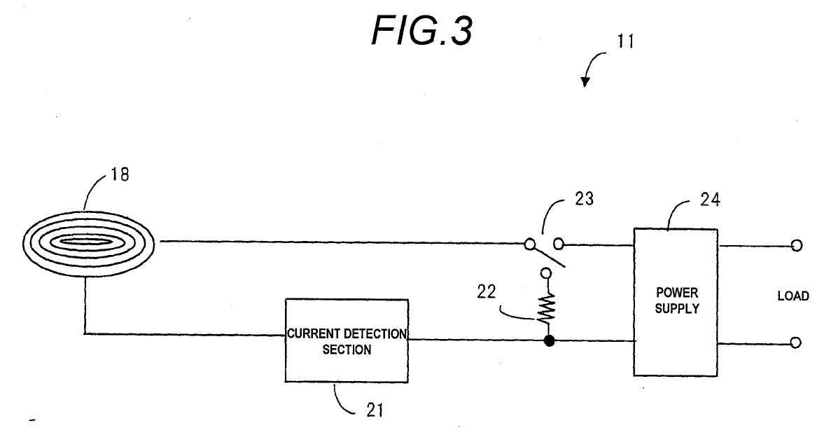

FIG. 3 shows an example of the configuration of the electronic device 11. The electronic device 11 uses a chargeable secondary battery as a power supply 24 and includes the non-contact (secondary) coil 18 for receiving power of charging the secondary battery through a magnetic flux, a power detection section 21 for detecting the value of a current flowing into the non-contact coil 18 when the non-contact coil 18 receives power, a comparison section (not shown) for making a comparison between the detected current value and a predetermined value (threshold value), the notification section 13 (see FIG. 1) for notifying the user that the relative position of the electronic device 11 to the charger 12 is appropriate if the detected current value is larger than a first predetermined value, a dummy load 22 temporarily connected to the non-contact coil 18, and a switch 23 for switching the dummy load 22 and the power supply 24.

The notification section may be configured in that, if the current value detected by the power detection section 21 is larger than a second predetermined value smaller than the first predetermined value and is smaller than the first predetermined value, the notification section 13 further notifies the user that the relative position of the electronic device 11 to the charger 12 is inappropriate.

The notification section 13 may be implemented as an illuminant such as a light emitting diode (LED), for example, and can be configured so as to provide notification concerning the relative position of the electronic device 11 according to a light emitting pattern of the illuminant.

The notification section 13 may contain a first illuminant and a second illuminant placed at different positions, so that the first illuminant and the second illuminant are lit at the same time if the relative position of the electronic device 11 to the charger 12 is appropriate.

In the electronic device 11, the notification section 13 may be implemented as a sounding body such as a buzzer and may also be configured so as to provide notification concerning the relative position of the electronic device 11 according to a sounding pattern of the sounding body.

Thus, the electronic device 11 uses a chargeable secondary battery as the power supply 24, for example, and includes the non-contact coil 18 for receiving power of charging the secondary battery in a non-contact manner from the outside, the power detection section 21 for detecting the value of a current flowing into the non-contact coil 18 when the non-contact coil 18 receives power, and the notification section 13 for notifying the user that the electronic device 11 is spatially placed in an appropriate state of charging the secondary battery if the detected current value is larger than the first predetermined value, so that the user can be easily notified of the position shift degree between the electronic device 11 and the charger 12 (for example, whether or not they are placed at appropriate positions).

Next, an example of the operation of the charging system 100 will be described.

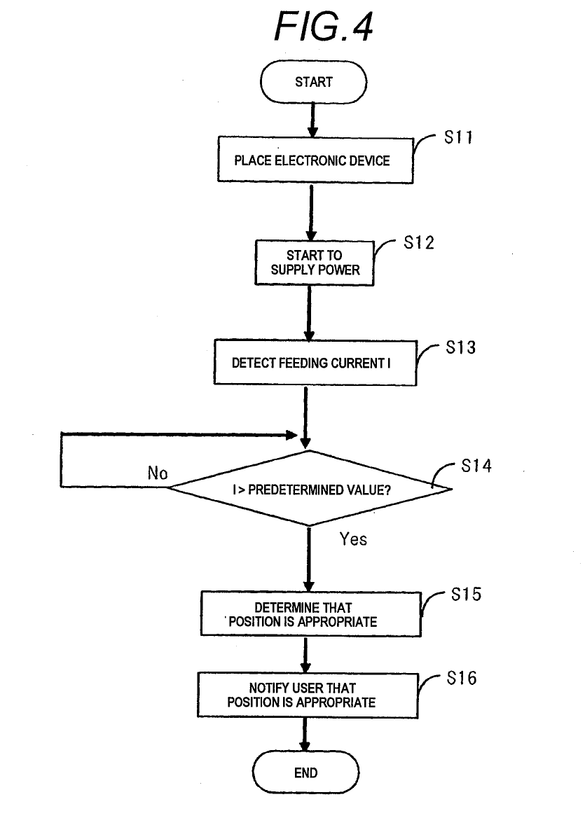

FIG. 4 is a flowchart to describe an example of the operation of the charging system 100.

When the electronic device 11 is placed on the periphery of the charger 12 for charging by the charger 12 (step S11), the charger 12 starts to supply power to the electronic device 11 (step S12). The power detection section 21 of the electronic device 11 detects a feeding current I flowing into the non-contact coil 18 (step S13) and the comparison section not shown determines whether or not the feeding current I is larger than the predetermined value (step S14).

If the feeding current I is larger than the predetermined value (Yes), it is determined that the relative position between the electronic device 11 and the charger 12 is appropriate (step S15) and the notification section 13 notifies the user that the position is appropriate (step S16). On the other hand, if the feeding current I is not larger than the predetermined value (No), the comparison between the feeding current I and the predetermined value is continued.

As a notifying method when the relative position between the electronic device 11 and the charger 12 is appropriate, light emission of the illuminant of the display section, indicator display, etc., sounding of the buzzer, etc., or the like is possible.

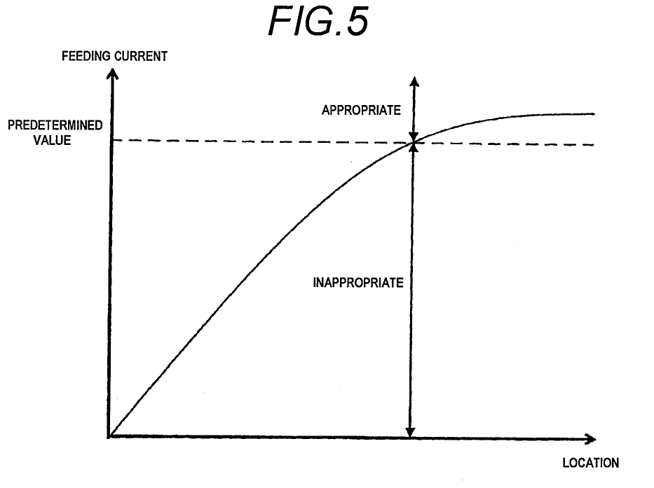

FIG. 5 is a graph to describe an example of change in the feeding current I in the electronic device for performing the processing in FIG. 4. The horizontal axis indicates the positional relationship between the electronic device 11 and the charger 12 (the distance therebetween) and the vertical axis indicates the feeding current value. FIG. 5 assumes that the electronic device 11 is brought close to the charger 12. If the feeding current is smaller than the predetermined value, it is determined that the position is inappropriate; if the feeding current is larger than the predetermined value, it is determined that the position is appropriate.

That is, if the current value detected by the power detection section 21 is larger than the first predetermined value, the notification 13 section notifies the user that the relative position of the electronic device 11 to the charger 12 is appropriate for charging and if the current value is smaller than the first predetermined value, the notification section 13 notifies the user that the relative position of the electronic device 11 to the charger 12 is inappropriate for charging.

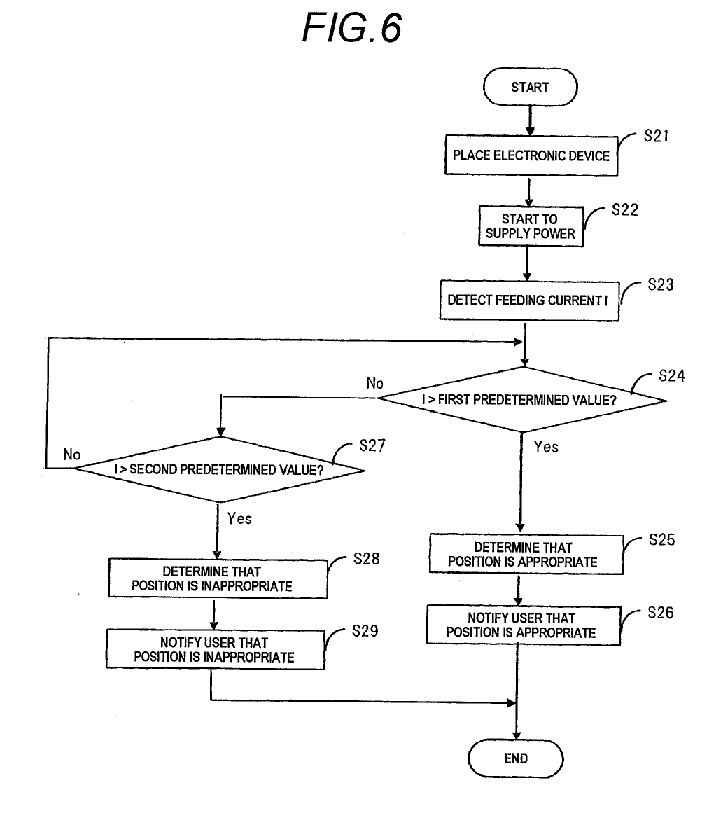

FIG. 6 is a flowchart to describe another example of the operation of the charging system 100.

When the electronic device 11 is placed on the periphery of the charger 12 for charging by the charger 12 (step S21), the charger 12 starts to supply power to the electronic device 11 (step S22). The power detection section 21 of the electronic device 11 detects a feeding current I flowing into the non-contact coil 18 (step S23) and the comparison section not shown determines whether or not the feeding current I is larger than a first predetermined value (step S24).

If the feeding current I is larger than the first predetermined value (Yes), it is determined that the relative position between the electronic device 11 and the charger 12 is appropriate (step S25) and the notification section 13 notifies the user that the position is appropriate (step S22). On the other hand, if the feeding current I is not larger than the predetermined value (No), the comparison section not shown determines whether or not the feeding current I is larger than a second predetermined value (step S27).

If the feeding current I is larger than the second predetermined value (Yes), it is determined that the relative position between the electronic device 11 and the charger 12 is inappropriate (step S28) and the notification section 13 notifies the user that the position is inappropriate (step S29). On the other hand, if the feeding current I is not larger than the second predetermined value (No), a return is made to just before step S24.

As a notifying method when the relative position between the electronic device 11 and the charger 12 is appropriate, light emission of the illuminant of the display section, indicator display, etc., sounding of the buzzer, etc., or the like is possible.

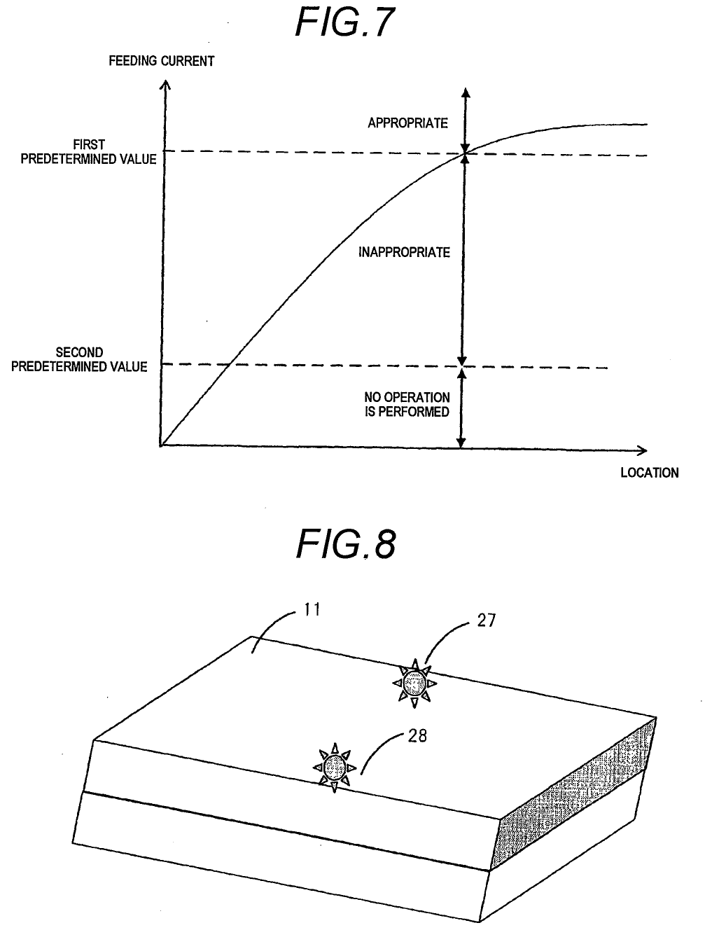

FIG. 7 is a graph to describe an example of change in the feeding current in the electronic device for performing the processing in FIG. 6. The horizontal axis indicates the positional relationship between the electronic device 11 and the charger 12 (the distance therebetween) and the vertical axis indicates the feeding current value. FIG. 7 assumes that the electronic device 11 is brought close to the charger 12. If the feeding current is smaller than the second predetermined value, no operation is performed; if the feeding current is larger than the second predetermined value and is smaller than the first predetermined value, it is determined that the position is inappropriate, and if the feeding current is larger than the first predetermined value, it is determined that the position is appropriate.

That is, if the current value detected by the power detection section 21 is larger than the second predetermined value smaller than the first predetermined value and is smaller than the first predetermined value, the notification section 13 notifies the user that the relative position of the electronic device 11 to the charger 12 is inappropriate for charging.

Thus, the notification section 13 notifies the user whether or not the relative position of the electronic device 11 to the charger 12 is appropriate for charging based on the current value detected by the power detection section 21.

The predetermined values in FIGS. 4 to 7 may be set by the electronic device 11.

Next, display examples of the notification section 13 will be described.

FIG. 8 is a perspective view of the electronic device 11 when the notification section 13 performs display. In FIG. 8, as an example of the notification section 13, a first illuminant 27 and a second illuminant 28 of LEDs, etc., are included on one side face of the electronic device 11. When the feeding current detected by the power detection section 21 is larger than the first predetermined value, the first illuminant 27 and the second illuminant 28 emit light for notifying the user that the relative position of the electronic device 11 to the charger 12 is appropriate.

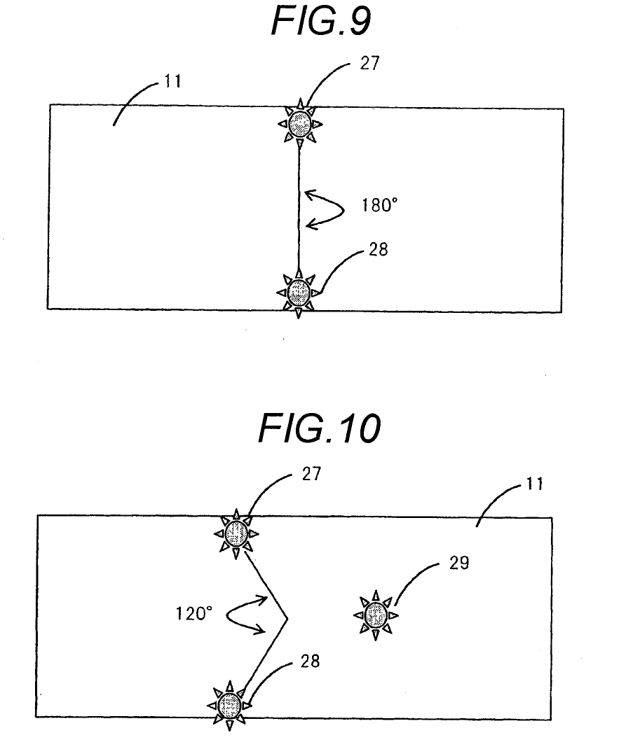

FIG. 9 shows a display example when the electronic device 11 has two illuminants as in FIG. 8 as the notification section 13. In FIG. 9, the electronic device 11 has the first illuminant 27 and the second illuminant 28 on one side face, which are placed in a line (180°). As a light emission example of the illuminants, if the relative position of the electronic device 11 to the charger 12 is appropriate, both the first illuminant 27 and the second illuminant 28 emit light; if the relative position of the electronic device 11 to the charger 12 is not appropriate, neither of the first illuminant 27 and the second illuminant 28 emit light. The number of illuminants for emitting light can also be changed in response to the strength of the feeding current.

FIG. 10 shows a display example when the electronic device 11 has three illuminants as the notification section 13. In FIG. 10, the electronic device 11 has the first illuminant 27, the second illuminant 28, and a third illuminant 29 on one side face, and the illuminants are placed at an angle of 120° with respect to the center position. As an light emission example of the illuminants, if the relative position of the electronic device 11 to the charger 12 is appropriate, all of the first illuminant 27, the second illuminant 28, and the third illuminant 29 emit light; if the relative position of the electronic device 11 to the charger 12 is not appropriate, none of the first illuminant 27, the second illuminant 28, and the third illuminant 29 emit light. The number of illuminants for emitting light can also be changed in response to the strength of the feeding current.

The number of illuminants to be placed may be four or more.

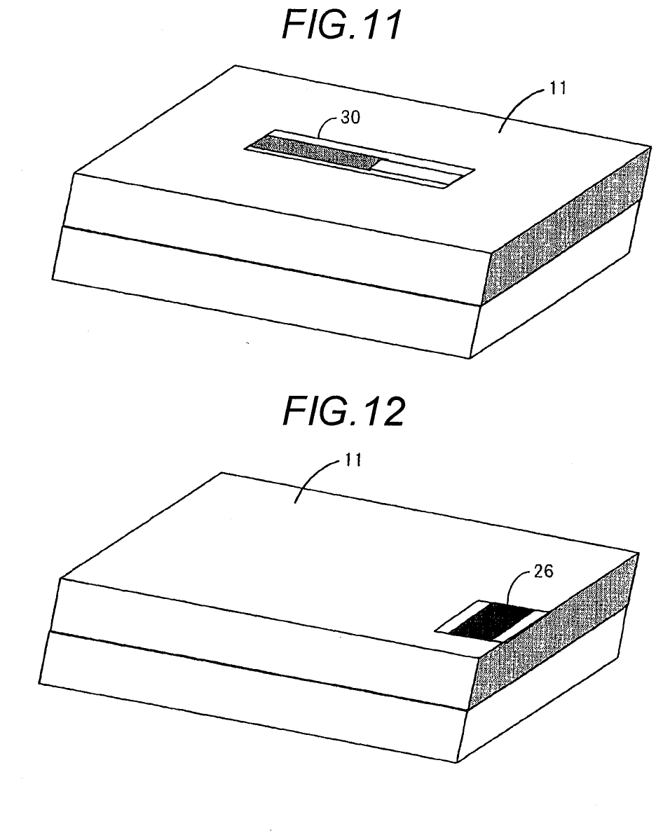

FIG. 11 is a perspective view of the electronic device 11 when the electronic device 11 has a position shift indicator 30 as the notification section 13 position shift indicator 30 displays a position shift and notifies the user that the relative position of the electronic device 11 to the charger 12 is appropriate. The position shift degree can also be displayed.

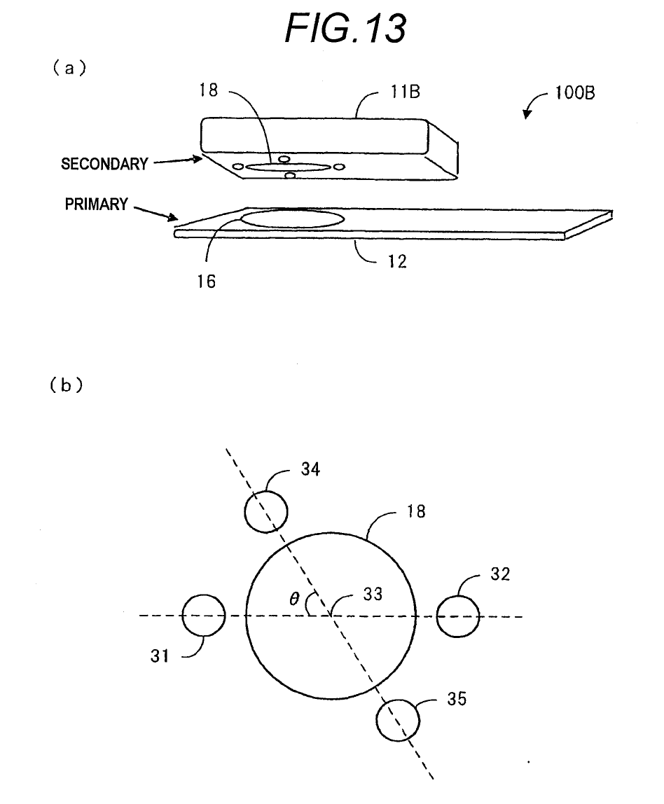

FIG. 12 is a perspective view of the electronic device 11 when the electronic device 11 has a two-color illuminant 26 for emitting two colors of red and green as the notification section 13. For example, if the detected feeding current is larger than the first setup value, the two-color illuminant 26 emits light of either red or green for notifying the user that the relative position of the electronic device 11 to the charger 12 is appropriate. In this case, the light emission color can be varied in response to the position shift degree.

The illuminant to be placed may be a two-color illuminant other than red or green or may be an illuminant of three or more colors.

According to the charging system 100, it is made possible for the electronic device 11 to determine whether or not the relative position of the electronic device 11 to the charger 12 is appropriate and provide notification for the user.

### Second Embodiment

In FIG. 13, (a) is a schematic view to show an example of a charging system 100B according to a second embodiment of the present invention. In FIG. 13, (b) shows an example of placement of a secondary coil 18 (in the embodiment, main coil) and position detection coils 31, 32, 34, and 35 of an electronic device 11B. The position detection coils 31, 32, 34, and 35 are used to determine the relative position of the electronic device 11B to a charger 12.

The charging system 100B has the electronic device 11B and the charger 12. The electronic device 11B has the position detection coils 31, 32, 34, and 35 and detects each position and compare according to the position detection coils. In the charging system 100B, the position detection coils (an example of magnetism detection section) are provided in the electronic device 11B, so that a position shift direction can be measured. Accordingly, in non-contact charging, the user is notified of a relative position shift between a primary coil 16 and the secondary coil 18, and a check sound is produced at the optimum position or light is emitted at the optimum position, so that the user can be requested to place the electronic device 11B at the optimum position.

Specifically, the electronic device 11B has the position detection coils 31, 32, 34, and 35 placed on the outer periphery of the secondary coil 18. If a shift from the primary coil 16 exits, the electronic device 11B determines which direction a shift exists in from the detection result of the position detection coils 31, 32, 34, and 35, and notifies the user of the correction direction. If the electronic device 11B is placed at the optimum position with no shift from the primary coil 16, the electronic device 11B notifies the user that the electronic device 11B is at the optimum position. If a position shift is detected in the electronic device 11B where the secondary coil 18 is placed, the user can be easily notified of the position shift direction and the shift degree using a position shift display section 39 of an example of notification section of the electronic device 11B (see (a) in FIG. 15).

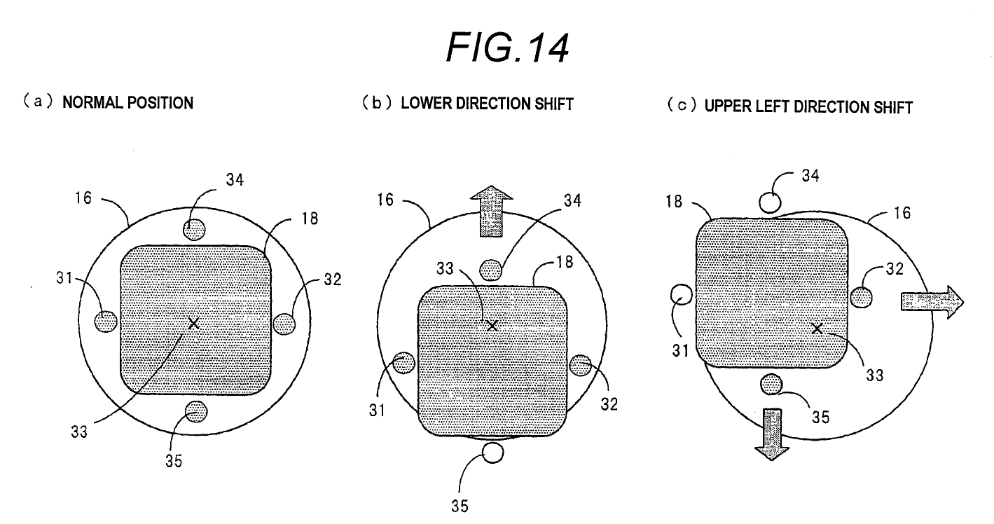

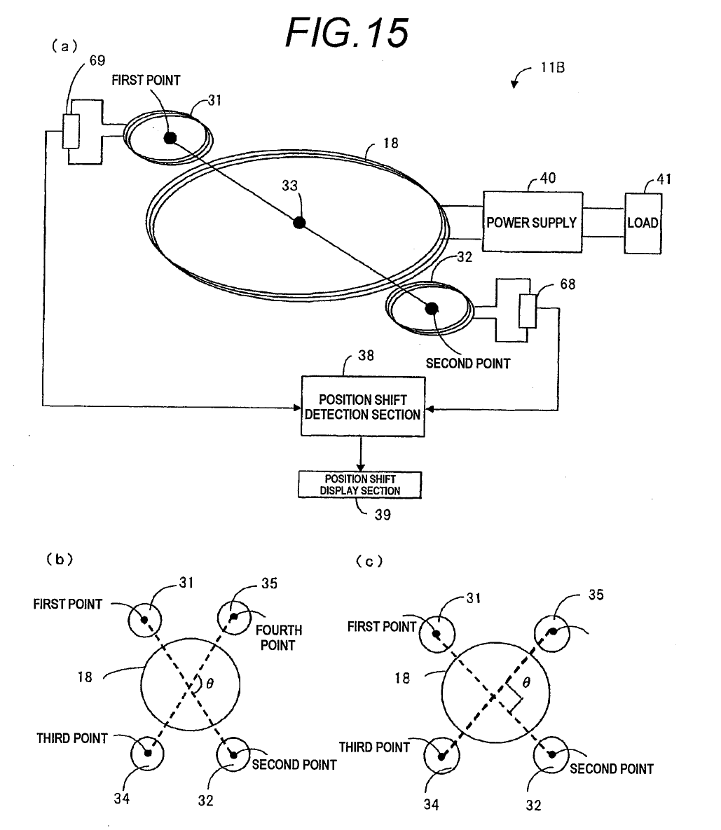

Next, an example of the positional relationship between the secondary coil 18 of the electronic device 11B and the primary coil 16 of the charger 12 will be described. FIG. 14 shows an example of the positional relationship between the secondary coil 18 of the electronic device 11B and the primary coil 16 of the charger 12.

In FIG. 14, (a) shows that the relative position of the electronic device 11B with respect to the charger 12 is the normal (appropriate) position, and a main point 33 of an in-plane center point of the secondary coil 18 matches the center of the primary coil 16. In this case, all of the position detection coils 31, 32, 34, and 35 are placed inside the primary coil 16, and equal power from the primary coil 16 is supplied to the position detection coils.

In FIG. 14, (b) shows that the relative position of the electronic device 11B with respect to the charger 12 shifts in a lower direction, and the position detection coil 35 is outside the primary coil 16. Therefore, in this case, power is not supplied to the position detection coil 35 in the lower direction and the magnetic flux density of a magnetic flux passing through the inside of the position detection coil 35 also becomes zero or small as compared with the ordinary value (the case (a) in FIG. 14).

In FIG. 14, (c) shows that the relative position of the electronic device 11B with respect to the charger 12 shifts in an upper left direction, and the position detection coils 31 and 34 are outside the primary coil 16. Therefore, in this case, power is not supplied to the position detection coil 31 in the left direction or the position detection coil 34 in the upper direction and the magnetic flux density of a magnetic flux passing through the inside of each of the position detection coils 31 and 34 also becomes zero or small as compared with the ordinary value (the case (a) in FIG. 14).

Thus, the relative position of the electronic device 11B shifts in the direction of the position detection coil receiving no power supply, the electronic device 11B compares the magnetic flux densities of magnetic fluxes passing through the insides of the upper and lower and right and left position detection coils and requests the user to shift the electronic device in the direction in which the magnetic flux density is large with an arrow, etc.

Next, an example of the configuration of the electronic device 11B will be described.

In FIG. 15, (a) is a configuration diagram to show an example of the configuration of the electronic device 11B.

The electronic device 11B has the secondary coil 18, a power supply section 40 connected to the secondary coil 18, to which power is supplied, a load 41 connected to the power supply section 40, the position detection coils 31 and 32 placed on the outer periphery of the secondary coil 18, a position shift detection section 38 connected to the position detection coils for detecting a position shift, and the position shift display section 39 connected to the position shift detection section 38 for displaying a position shift for the user. Here, only the position detection coils 31 and 32 are shown, but four (position detection coils 31, 32, 34, and 35) may exist. The case where the number of position detection coils is four will be described below:

The secondary coil 18 has a conductor wire wound around the main point 33 in (b) of FIG. 13 and receives power for charging a secondary battery from the charger 12.

The position detection coil 31 is placed at a first point on the outer periphery of the secondary coil 18 in the electronic device 11B. The position detection coil 32 is placed at a second point on the outer periphery of the secondary coil 18 in the electronic device 11B. The position detection coil 34 is placed at a third point on the outer periphery of the secondary coil 18 in the electronic device 11B. The position detection coil 35 is placed at a fourth point on the outer periphery of the secondary coil 18 in the electronic device 11B. Each coil has a conductor wire wound in the predetermined same number of turns in the predetermined same shape around a predetermined point.

As shown in (b) and (c) of FIG. 15, the second point can be placed symmetrically with respect to the first point about the main point 33. The fourth point can be placed symmetrically with respect to the third point about the main point 33. Particularly, as shown in (c) of FIG. 15, a straight line connecting the first point and the second point and a straight line connecting the third point and the fourth point can be configured so as to cross at a predetermined angle θ, for example, substantially 90 degrees.

The secondary coil 18 includes a flat coil placed along a predetermined plane and the position detection coils 31, 32, 34, and 35 are placed along the predetermined plane (face along the plane of FIG. 15). According to the configuration, slimming down of the electronic device 11B is accomplished.

The position shift detection section 38 detects a position shift based on the magnetic flux density detected by each of the position detection coils 31, 32, 34, and 35.

The position shift display section 39 displays information of a position shift detected by the position shift detection section 38. Here, the information of a position shift is displayed to provide notification for the user, but the mode is not limited to it; for example, a sound may be produced for providing notification for the user.

As the operation of the position shift display section 39, for example, it becomes possible that if the magnetic flux density detected by the position detection coil 31 is higher than the magnetic flux density detected by the position detection coil 32, the user is prompted to move the electronic device 11B from the second point to the first point; if the magnetic flux density detected by the position detection coil 32 is higher than the magnetic flux density detected by the position detection coil 31, the user is prompted to move the electronic device 11B from the first point to the second point. It also becomes possible, for example, if the magnetic flux density detected by the position detection coil 34 is higher than the magnetic flux density detected by the position detection coil 35, the user is prompted to move the electronic device 11B from the fourth point to the third point; if the magnetic flux density detected by the position detection coil 35 is higher than the magnetic flux density detected by the position detection coil 34, the user is prompted to move the electronic device 11B from the third point to the fourth point.

In other words, it becomes possible that if the electromotive force of the position detection coil 31 is larger than the electromotive force of the position detection coil 32, the user is prompted to move the electronic device 11B from the position detection coil 32 to the position detection coil 31; if the electromotive force of the position detection coil 32 is larger than the electromotive force of the position detection coil 31, the user is prompted to move the electronic device 11B from the position detection coil 31 to the position detection coil 32. It also becomes possible, for example, if the electromotive force of the position detection coil 34 is larger than the electromotive force of the position detection coil 35, the user is prompted to move the electronic device 11B from the position detection coil 35 to the position detection coil 34; if the electromotive force of the position detection coil 35 is larger than the electromotive force of the position detection coil 34, the user is prompted to move the electronic device 11B from the position detection coil 34 to the position detection coil 35.

The position shift display section 39 may include a plurality of illuminants of light emitting diodes (LEDs), etc., for example, and can prompt the user to move the electronic device 11B according to a light emitting pattern of the illuminants.

Here, the position detection coils 31, 32, 34, and 35 are used to detect the magnetic flux density, but a magnetism detection element (for example, a hole element, etc.,) capable of detecting the magnetic flux density can also be used in addition to the coils.

Next, a placement example of the position detection coils 31, 32, 34, and 35 will be described.

In FIG. 15, (b) shows the case where the straight line connecting the center of the position detection coil 31 and the center of the position detection coil 32 and the straight line connecting the center of the position detection coil 34 and the center of the position detection coil 35 cross at the angle θ in the electronic device 11B. In FIG. 15, (c) shows the case where the straight line connecting the center of the position detection coil 31 and the center of the position detection coil 32 and the straight line connecting the center of the position detection coil 34 and the center of the position detection coil 35 cross at 90 degrees in the electronic device 11B.

When they cross at the angle θ, for example, in (b) of FIG. 15, the position detection coils are placed with a narrow spacing in a lateral direction (the position detection coils 31 and 35 and the position detection coils 34 and 32) and the position detection coils are placed with a wide spacing in a longitudinal direction (the position detection coils 31 and 34 and the position detection coils 35 and 32). In this case, a position shift in the lateral direction can be detected with higher accuracy than that in the longitudinal direction according to the magnetic flux density detected by the position detection coil. Thus, when the straight lines cross at the angle θ, a position shift in a direction in which the position detection coils are placed with a narrow spacing can be detected with higher accuracy than that in a direction in which the position detection coils are placed with a wide spacing.

On the other hand, when the straight lines cross at 90 degrees, namely, in (c) of FIG. 15, the position detection coils are placed with an equal spacing in the lateral direction and the longitudinal direction. In this case, a position shift can be detected with the same accuracy in both the lateral direction and the longitudinal direction.

Thus, to prevent the position shift detection accuracy from varying depending on the direction, it is desirable that the straight line connecting the center of the position detection coil 31 and the center of the position detection coil 32 and the straight line connecting the center of the position detection coil 34 and the center of the position detection coil 35 should cross at angle θ=90 degrees.

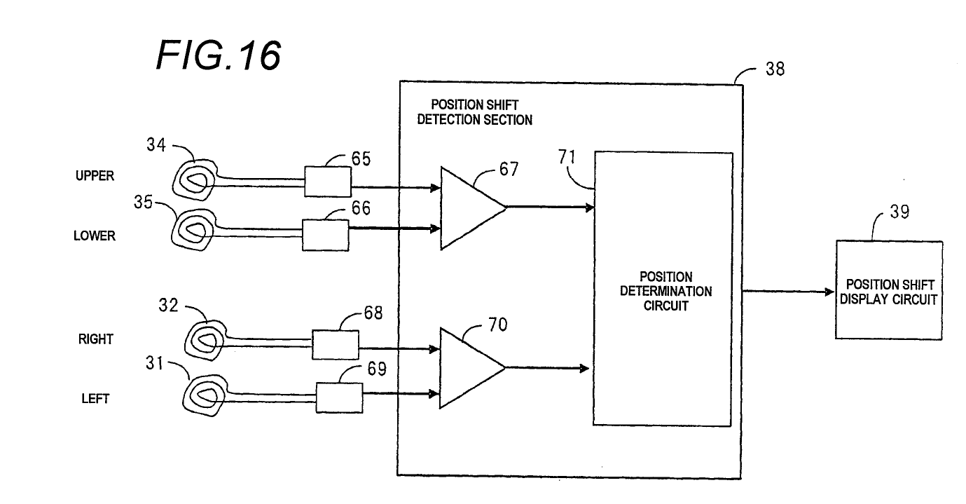

Next, an example of the detailed configuration to detect a position shift of the electronic device 11B will be described. FIG. 16 shows an example of the detailed configuration to detect a position shift of the electronic device 11B.

The position shift detection section 38 has rectification circuits 65 and 66 for rectifying detection signals of the upper and lower position detection coils 34 and 35, a comparison circuit 67 for making a comparison between output signals of the rectification circuits 65 and 66, rectification circuits 68 and 69 for rectifying detection signals of the right and left position detection coils 31 and 32, a comparison circuit 70 for making a comparison between output signals of the rectification circuits 68 and 69, and a position determination circuit 71 for determining the position of the electronic device 11B in response to plus or minus of the output signals of the comparison circuits 67 and 70, for example.

The position shift display circuit 39 is an example of the position shift display section 39 and displays an arrow, for example, for the user so as to place the electronic device 11B at the optimum position relative to the charger 12 in response to the determination result of the position determination circuit 71. Notification may be provided for the user according to any method other than the arrow display.

Next, an example of the operation for the electronic device 11B to detect a position shift will be described.

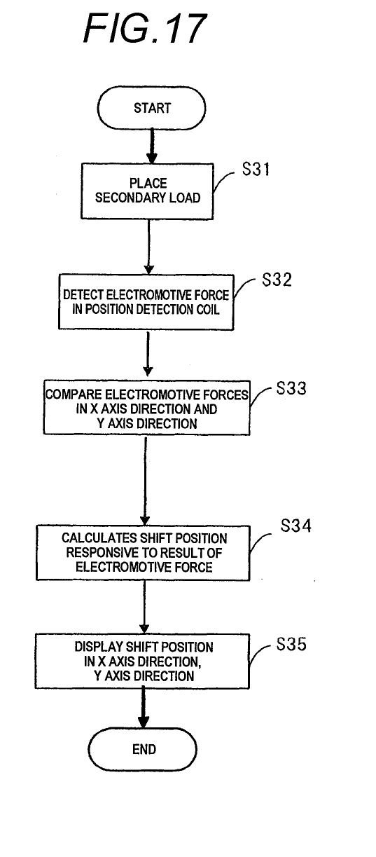

FIG. 17 is a flowchart to show an example of the operation for the electronic device 11B to detect a position shift. In FIG. 17, it is assumed that an X axis direction indicates a direction of the straight line connecting the first point and the second point, that a Y axis direction indicates a direction of the line connecting the third point and the fourth point, and that the angle between the X axis and the Y axis is the right angle.

When the electronic device 11B of secondary load is placed a predetermined position relative to the charger 12 (step S31), the position detection coils 31, 32, 34, and 35 detect an electromotive force (step S32).

Subsequently, the comparators 67 and 70 compare electromotive forces in the X axis direction and the Y axis direction (step S33), the position determination circuit 71 calculates a shift position responsive to the result of the electromotive force (step S34), and the position shift display section 39 displays shift position in the X axis direction, the Y axis direction (step S35). Here, the shift position is information indicating which direction and how much the electronic device 11B shifts in from the normal position (see (a) in FIG. 14), for example.

Next, display examples of the position shift display section 39 will be described.

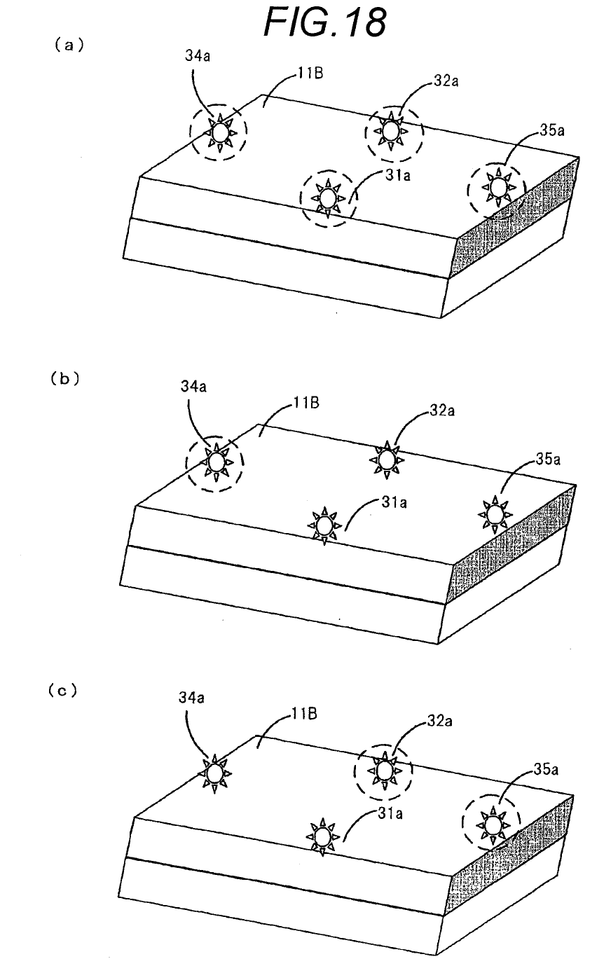

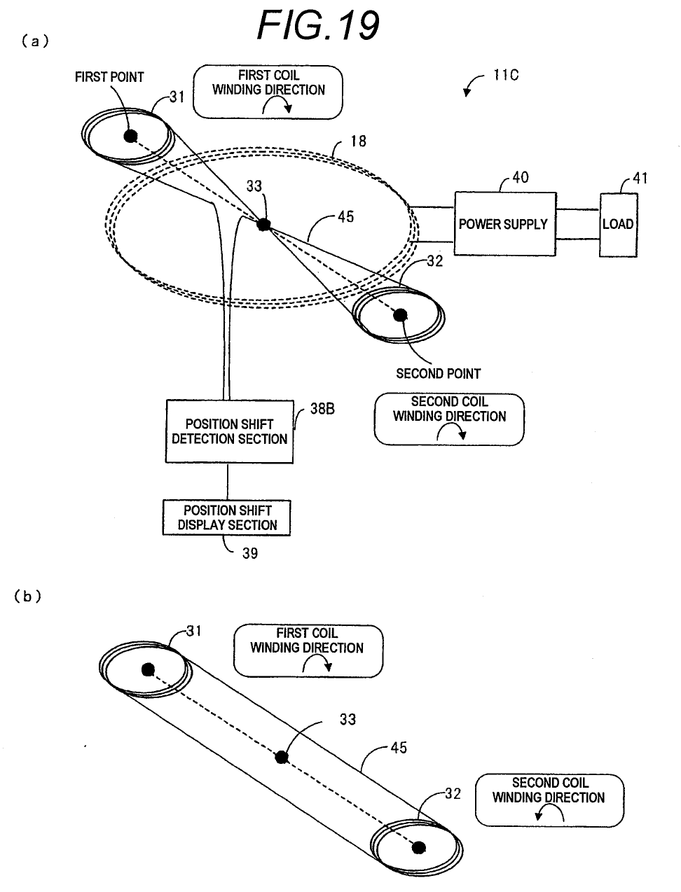

FIG. 18 shows an example of a perspective view of the electronic device 11B for the position shift display section 39 to perform display. FIG. 18 shows the case where the electronic device 11B includes four illuminants as the position shift display section 39. FIG. 18 assumes that an illuminant 31a is placed at a position on a cabinet of the electronic device 11B corresponding to the position of the position detection coil 31, an illuminant 32a is placed at a position on the cabinet of the electronic device 11B corresponding to the position of the position detection coil 32, an illuminant 34a is placed at a position on the cabinet of the electronic device 11B corresponding to the position of the position detection coil 34, and an illuminant 35a is placed at a position on the cabinet of the electronic device 11B corresponding to the position of the position detection coil 35.

In FIG. 18, (a) shows the case where the relative position of the electronic device 11B to the charger 12 is the normal position as in (a) of FIG. 14. In this case, all illuminants 31a, 32a, 33a, and 34a emit light.

In FIG. 18, (b) shows the case where the relative position of the electronic device 11B to the charger 12 shifts in the lower direction as in (b) of FIG. 14, namely, the position detection coil 35 does not receive power supply. In this case, the illuminant 34a emits light.

In FIG. 18, (c) shows the case where the relative position of the electronic device 11B to the charger 12 shifts in the upper right direction as in (c) of FIG. 14, namely, the position detection coils 31 and 34 do not receive power supply. In this case, the illuminants 32a and 35a emit light.

Here, the position shift display section 39 causes the illuminant in the opposite direction to the shift direction in case other than at the normal position to emit light by way of example, but an arrow may be displayed in the opposite direction to the shift direction in place of light emission. The user may be notified of a position shift by any other method if the user can recognize the shift direction.

According to the charging system 100B, if the coil position for the electronic device 11B to receive power for charging in a non-contact manner shifts relatively to the position of the charger 12, it is made possible to notify the user of the optimum position to place the electronic device 11B at the optimum position. If the electronic device 11B is at the optimum position, the user can recognize that the electronic device 11B is at the optimum position. It is made possible to place the electronic device 11B at the optimum position, so that power transmission efficiency from the charger 12 to the electronic device 11B improves and it is made possible to shorten the charging time.

### Third Embodiment

Next, a charging system 100C having a similar configuration to that of the charging system 100B shown in (a) of FIG. 13 will be described. The charging system 100C has an electronic device 11C and a charger 12. A schematic view to show an example of the charging system 100C is the same as (a) in FIG. 13 except for the electronic device 11C rather than 11B. A drawing to show an example of the positional relationship between a secondary coil 18 (main coil in the embodiment) of the electronic device 11C and a primary coil 16 of the charger 12 is similar to FIG. 14 and therefore description is omitted.

In FIG. 19, (a) shows an example of the configuration of the electronic device 11C. Components identical with those of the electronic device 11B shown in (a) of FIG. 15 are denoted by the same reference numerals and will not be described again or will be described briefly.

The electronic device 11C has a secondary coil 18, a power supply section 40 connected to the secondary coil 18, to which power is supplied, a load 41 connected to the power supply section 40, a loop circuit 45 provided by connecting a position detection coil 31 and a position detection coil 32 placed on the outer periphery of the secondary coil 18, a position shift detection section 38B connected to the loop circuit 45 for detecting a position shift, and a position shift display section 39 connected to the position shift detection section 38B for displaying a position shift for the user. Here, only the position detection coils 31 and 32 are shown, but four (position detection coils 31, 32, 34, and 35) may exist. The case where the number of position detection coils is four will be described below:

In the loop circuit 45, a high voltage end of the position detection coil 31 is connected to a high voltage end of the position detection coil 32 and a low voltage end of the position detection coil 31 is connected to a low voltage end of the position detection coil 32.

In the loop circuit 45, if the electromotive force of the position detection coil 31 is equal to the electromotive force of the position detection coil 32, no current flows; if the electromotive force of the position detection coil 31 differs from the electromotive force of the position detection coil 32, a current flows into the loop circuit. Accordingly, the position shift display section 39 can notify the user of information of a position shift in response to the presence or absence and the direction of the current flowing into the loop circuit.

In (a) of FIG. 19, as the loop circuit 45, a loop circuit wherein the winding directions of the position detection coil 31 and the position detection coil 32 are the same and the coils are cross-connected (8-shaped coil) is adopted, but a loop circuit of any other shape may be formed. For example, as shown in (b) of FIG. 19, as the loop circuit 45, a loop circuit wherein the winding directions of the position detection coil 31 and the position detection coil 32 are made opposite and the coils are connected as they are not crossed (non-8-shaped coil) can also be adopted.

A loop circuit 45 provided by connecting the position detection coil 34 and the position detection coil 35 has a similar configuration to that described above.

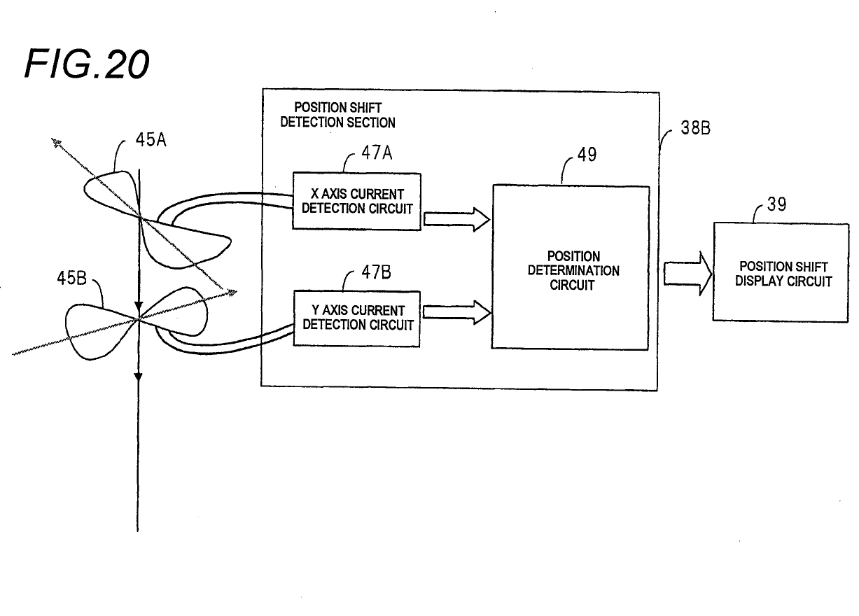

Next, an example of the detailed configuration to detect a position shift of the electronic device 11C will be described. FIG. 20 shows an example of the detailed configuration to detect a position shift of the electronic device 11C.

The position shift detection section 38B has an X axis current detection circuit 47A, a Y axis current detection circuit 47B, and a position determination circuit 49.

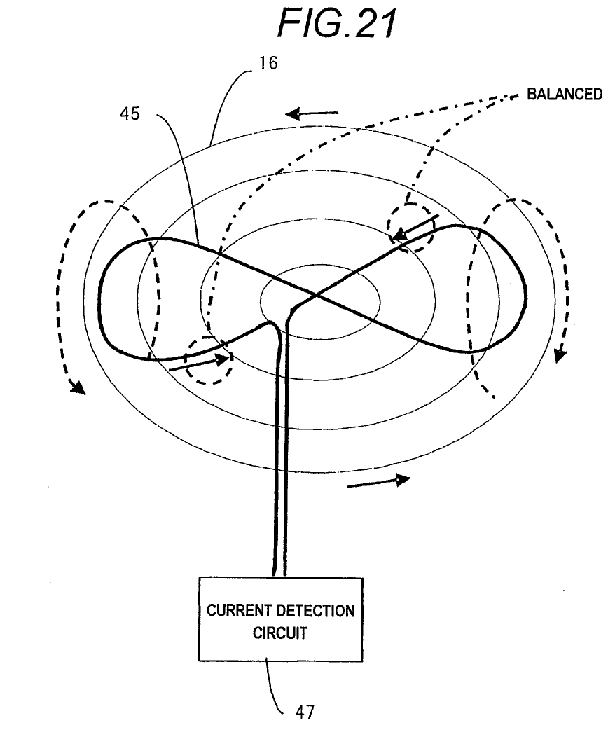

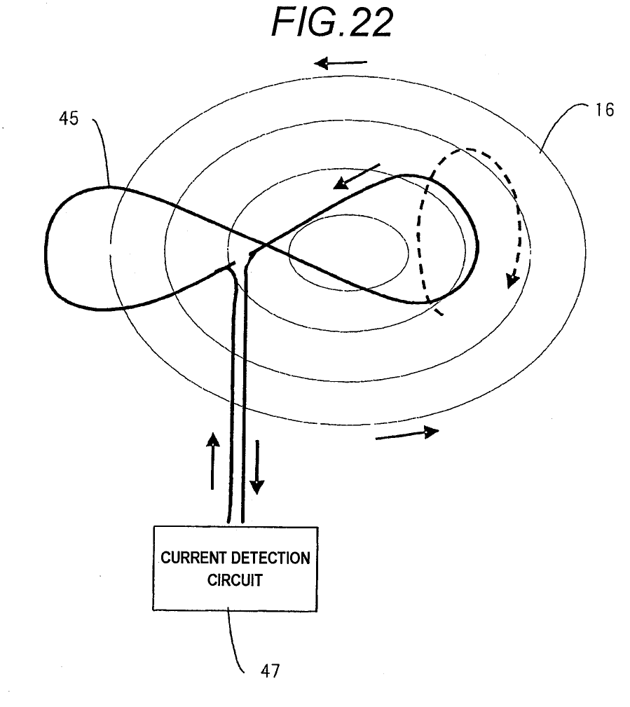

The X axis current detection circuit 47A detects a current flowing into an X axis loop circuit 45A provided by cross-connecting the position detection coil 31 and the position detection coil 32. The X axis loop circuit 45A is an example of the loop circuit 45. An example of a current detection method is shown in FIGS. 21 and 22.

The Y axis current detection circuit 47B detects a current flowing into a Y axis loop circuit 45B provided by cross-connecting the position detection coil 34 and the position detection coil 35. The Y axis loop circuit 45B is an example of the loop circuit 45. An example of a current detection method is shown in FIGS. 21 and 22.

The position determination circuit 49 is connected to the X axis detection circuit 47A and the Y axis detection circuit 47B and determines a position shift between the electronic device 11C and the charger 12 based on the currents detected in the X axis detection circuit 47A and the Y axis detection circuit 47B.

Next, an example of a current flowing through the loop circuit 45 will be described.

FIG. 21 shows an example of a current flowing through the loop circuit 45 when the relative position of the electronic device 11C to the charger 12 is appropriate. If the center of the loop circuit 45 is placed, for example, just above the center of the primary coil 16, the magnitude of the electromotive force of the position detection coil 31 is equal to that of the position detection coil 32 and thus the current from the position detection coil 31 and the current from the position detection coil 32 cancel each other and no current flows into the loop circuit 45.

FIG. 22 shows an example of a current flowing through the loop circuit 45 when the relative position of the electronic device 11C to the charger 12 is not appropriate. If the center of the loop circuit 45 is placed, for example, at a predetermined distance or more from just above the center of the primary coil 16, the magnitude of the electromotive force of the position detection coil 31 differs from that of the position detection coil 32, and thus the current from the position detection coil 31 and the current from the position detection coil 32 do not cancel each other and a current flows into the loop circuit 45. In this case, the direction of a position shift and the shift state can be determined according to the flowing direction and the magnitude of the current and the user can be requested to place the electronic device 11C at the optimum position.

Next, an example of the operation for the electronic device 11C to detect a position shift will be described.

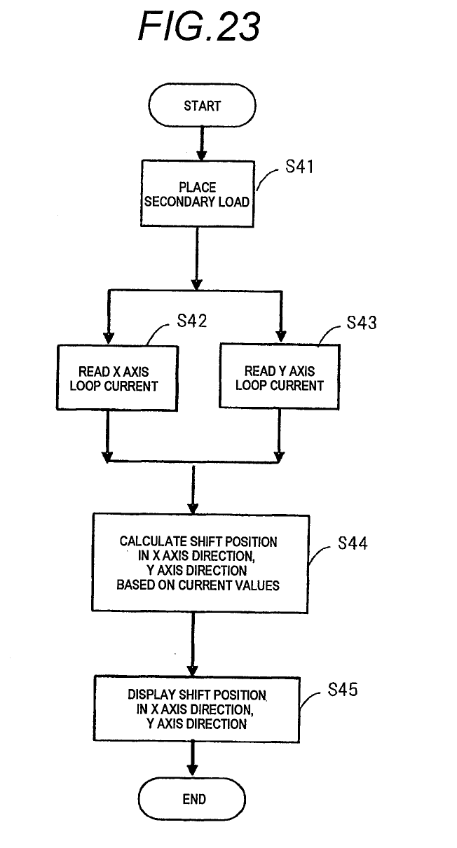

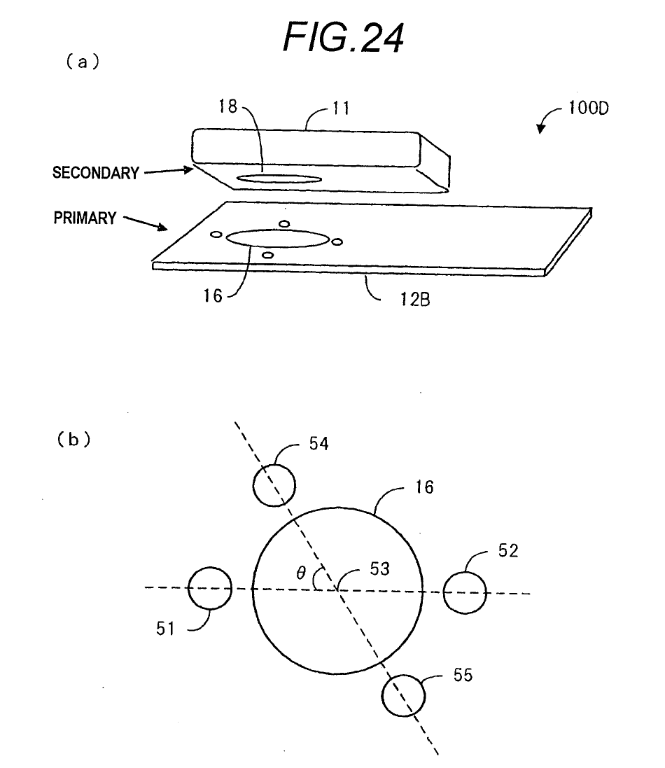

FIG. 23 is a flowchart to show an example of the operation for the electronic device 11 to detect a position shift. In FIG. 23, it is assumed that an X axis direction indicates a direction of the straight line connecting a first point and a second point, that a Y axis direction indicates a direction of the straight line connecting a third point and a fourth point, and that the angle between the X axis and the Y axis is the right angle.

When the electronic device 11C of secondary load is placed at a predetermined position relative to the charger 12 (step S41), the X axis current detection circuit 47A reads an X axis loop current (step S42) and the Y axis current detection circuit 47B reads a Y axis loop current (step S43).

Subsequently, the position determination circuit 49 calculates a shift position in the X axis direction, the Y axis direction based on the current values read by the X axis current detection circuit 47A and the Y axis current detection circuit 47B (step S44). The position shift display section 39 displays the shift position in the X axis direction, the Y axis direction calculated by the position determination circuit 49 (step S45).

According to the processing in FIG. 23, the shift direction and the shift state can be determined according to the flowing direction and the magnitude of the current and an arrow can be displayed, etc., so as to place the electronic device at the optimum position. Here, four position detection coils are used to form the X axis and Y axis loops; however, the operation when only two position detection coils are included is performed considering the X axis loop only, for example.

The position shift display section 39 displays the shift position as in the display example described in the second embodiment (see FIG. 18).

According to the charging system 100C, if the coil position for the electronic device 11C to receive power for charging in a non-contact manner shifts relatively to the position of the charger 12, it is made possible to notify the user of the optimum position to place the electronic device 11C at the optimum position. If the electronic device 11C is at the optimum position, the user can recognize that the electronic device 11C is at the optimum position. It is made possible to place the electronic device 11C at the optimum position, so that power transmission efficiency from the charger 12 to the electronic device 11C improves and it is made possible to shorten the charging time.

Further, when the electronic device 11C is placed at the optimum position, no current flows into the loop circuit 45, so that it is made possible to decrease power consumption.

### Fourth Embodiment

In FIG. 24, (a) is a schematic view to show an example of a charging system 100D according to a fourth embodiment of the present invention. The charging system 100D has an electronic device 11 and a charger 12B. In the charging system 100D, the charger 12B detects the position of the electronic device 11 and produces a check sound at the optimum position or emits light at the optimum position, whereby the electronic device 11 can be positioned correctly.

In FIG. 24, (b) shows a placement example of a primary coil 16 (main coil in the embodiment) and position detection coils 51, 52, 54, and 55 of the charger 12B. As shown in (b) of FIG. 24, the position detection coils 51, 52, 54, and 55 are placed in the surrounding of the primary coil 16 of the charger 12B. When a secondary coil of the electronic device 11 is placed at a predetermined position relative to the primary coil 16 of the charger 12B, the secondary coil 18 receives power according to a magnetic flux from the primary coil 16. Magnetic flux corresponding to power not received by the secondary coil 18 is detected as a leakage magnetic flux by the position detection coils 51, 52, 54, and 55. If the position detection coils 51, 52, 54, and 55 detect a leakage magnetic flux, an electromotive force occurs and current flowing into the coils changes.

The leakage magnetic flux is a magnetic flux except the magnetic flux inducing power into the secondary coil 18, of the magnetic flux generated from the primary coil 16.

The charging system 100D detects a position shift of the secondary coil 18 relative to the primary coil 16 according to current change of the position detection coil 51, 52, 54, 55. The user of the electronic device 11 can be notified of the result by a position shift display section 139 of an example of a notification section of the charger 12B (see (a) of FIG. 26) so as to place the electronic device 11 at a position where the electronic device 11 can be charged correctly (the power transmission efficiency is high).

In the embodiment, the electronic device 11 need not include a function for determining the relative position to the charger 12B.

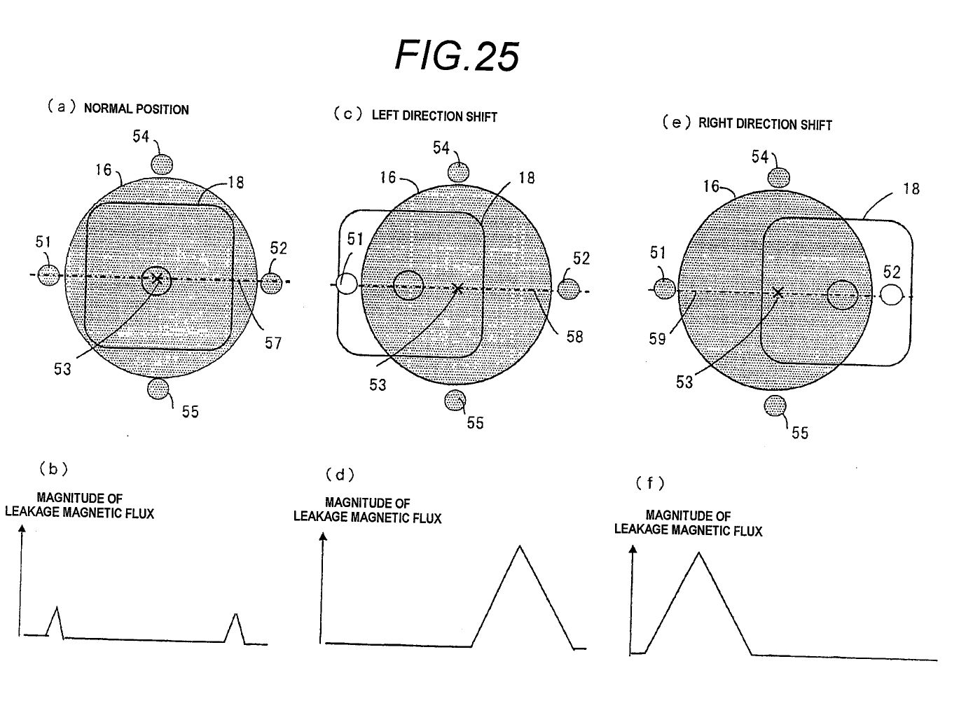

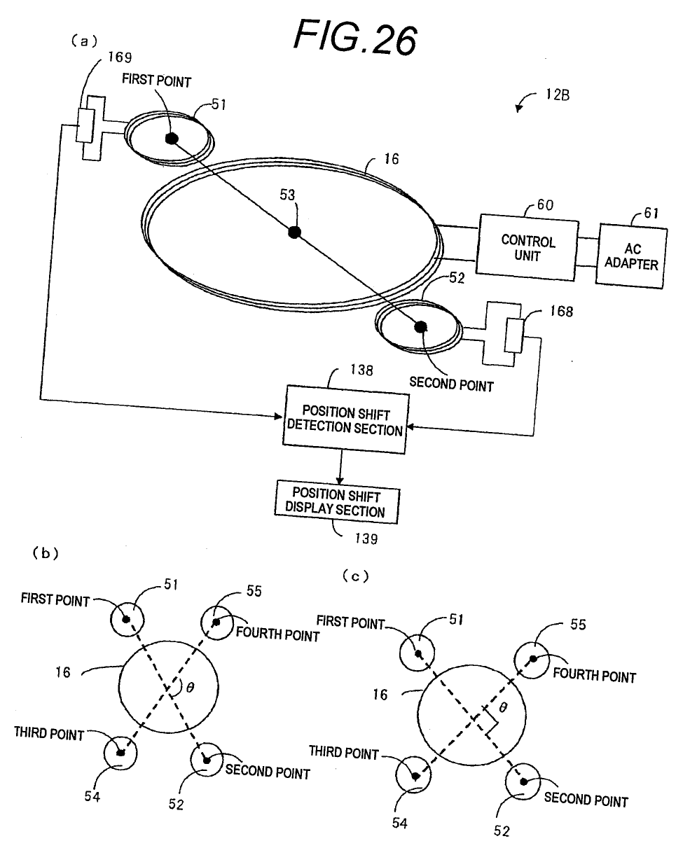

Next, an example of the positional relationship between the primary coil 16 of the charger 12B and the secondary coil 18 of the electronic device 11 will be described. FIG. 25 shows an example of the positional relationship between the primary coil 16 of the charger 12B and the secondary coil 18 of the electronic device 11.

In FIG. 25, (a) shows that the relative position of the electronic device 11 to the charger 12B is the normal (appropriate) position, and the center of the secondary coil 18 matches a main point 53 of an in-plane center point of the primary coil 16. In this case, all of the position detection coils 51, 52, 54, and 55 are placed outside the secondary coil 18. Therefore, leakage magnetic flux on a dashed line 57 shown in (a) of FIG. 25 becomes as shown in (b) of FIG. 25 and a magnetic flux is not much detected in the position detection coil 51 or the position detection coil 52. An electromotive force scarcely occurs in the position detection coil 51, 52, 54, 55.

In FIG. 25, (c) shows that the relative position of the electronic device 11 to the charger 12B shifts in the left direction, and the position detection coil 51 enters the inside of the secondary coil 18. In this case, leakage magnetic flux on a dashed line 58 shown in (c) of FIG. 25 becomes as shown in (d) of FIG. 25 and a magnetic flux is scarcely detected in the position detection coil 51 and a magnetic flux is much detected in the position detection coil 52. That is, the magnetic flux on the opposite side to the shift direction of the secondary coil 18 of the electronic device 11 increases and in (c) of FIG. 25 (c), an electromotive force occurs in the position detection coil 52.

In FIG. 25, (e) shows that the relative position of the electronic device 11 to the charger 12B shifts in the right direction, and the position detection coil 52 enters the inside of the secondary coil 18. In this case, leakage magnetic flux on a dashed line 59 shown in (e) of FIG. 25 becomes as shown in (f) of FIG. 25 and a magnetic flux is scarcely detected in the position detection coil 52 and a magnetic flux is much detected in the position detection coil 51. That is, the magnetic flux on the opposite side to the shift direction of the secondary coil 18 of the electronic device 11 increases and in (e) of FIG. 25, an electromotive force occurs in the position detection coil 51.

Thus, the electronic device 11 shifts in the direction of the position detection coil in which electromotive force caused by leakage magnetic flux occurs and thus the levels of the upper and lower and right and left position detection coils are compared and the user is notified so as to shift the device in the large direction with an arrow, etc.

Next, an example of the configuration of the charger 12B will be described.

In FIG. 26, (a) shows an example of the configuration of the charger 12B.

The charger 12B has a primary coil 16, a control unit 60 connected to the primary coil 16 for controlling power supply, an AC adapter 61 connected to the control unit 60, a position detection coil 51 and a position detection coil 52 placed on the outer periphery of the secondary coil 16, a position shift detection section 138 connected to the position detection coils for detecting a position shift, and a position shift display section 139 connected to the position shift detection section 138 for displaying a position shift for the user. Here, only two position detection coils (position detection coils 51 and 52) are shown, but four (position detection coils 51, 52, 54, and 55) may exist. The case where the number of position detection coils is four will be described below:

The primary coil 16 has a conductor wire wound around a main point 53 and sends power for charging a secondary battery of the electronic device 11 to the charger 12.

The position detection coil 51 is placed at a first point on the outer periphery of the primary coil 16 in the charger 12B. The position detection coil 52 is placed at a second point on the outer periphery of the primary coil 16 in the charger 12B. The position detection coil 54 is placed at a third point on the outer periphery of the primary coil 16 in the charger 12B. The position detection coil 55 is placed at a fourth point on the outer periphery of the primary coil 16 in the charger 12B. Each coil has a conductor wire wound in the predetermined same number of turns in the predetermined same shape around a predetermined point.

As shown in (b) and (c) of FIG. 26, the second point can be placed symmetrically with respect to the first point about the main point 53. The fourth point can be placed symmetrically with respect to the third point about the main point 53. Particularly, as shown in (c) of FIG. 26, the straight line connecting the first point and the second point and the straight line connecting the third point and the fourth point can be configured so as to cross at a predetermined angle θ, for example, substantially 90 degrees.

The primary coil 16 includes a flat coil placed along a predetermined plane and the position detection coils 51, 52, 54, and 55 are placed along the predetermined plane. According to the configuration, slimming down of the charger 12B is accomplished.

The position shift detection section 138 detects a position shift based on the magnetic flux density detected by each of the position detection coils 51, 52, 54, and 55.

The position shift display section 139 displays information of a position shift detected by the position shift detection section 138. Here, the information of a position shift is displayed to provide notification for the user, but the mode is not limited to it; for example, a sound may be produced for providing notification for the user.

As the operation of the position shift display section 139, it becomes possible that, for example, if the magnetic flux density detected by the position detection coil 51 is higher than the magnetic flux density detected by the position detection coil 52, the user is prompted to move the electronic device 11 from the second point to the first point; if the magnetic flux density detected by the position detection coil 52 is higher than the magnetic flux density detected by the position detection coil 51, the user is prompted to move the electronic device 11 from the first point to the second point. It also becomes possible that, for example, if the magnetic flux density detected by the position detection coil 54 is higher than the magnetic flux density detected by the position detection coil 55, the user is prompted to move the electronic device 11 from the fourth point to the third point; if the magnetic flux density detected by the position detection coil 55 is higher than the magnetic flux density detected by the position detection coil 54, the user is prompted to move the electronic device 11 from the third point to the fourth point.

In other words, it becomes possible that if the electromotive force of the position detection coil 51 is larger than the electromotive force of the position detection coil 52, the user is prompted to move the electronic device 11 from the position detection coil 52 to the position detection coil 51; if the electromotive force of the position detection coil 52 is larger than the electromotive force of the position detection coil 51, the user is prompted to move the electronic device 11 from the position detection coil 51 to the position detection coil 52. It also becomes possible that, for example, if the electromotive force of the position detection coil 54 is larger than the electromotive force of the position detection coil 55, the user is prompted to move the electronic device 11 from the position detection coil 55 to the position detection coil 54; if the electromotive force of the position detection coil 55 is larger than the electromotive force of the position detection coil 54, the user is prompted to move the electronic device 11 from the position detection coil 54 to the position detection coil 55.

The position shift display section 139 may include a plurality of illuminants of light emitting diodes (LEDs), etc., for example, and can prompt the user to move the electronic device 11 according to a light emitting pattern of the illuminants.

Here, the position detection coils 51, 52, 54, and 55 are used to detect the magnetic flux density, but a magnetism detection element (for example, a hole element, etc.,) capable of detecting the magnetic flux density can also be used in addition to the coils.

Next, a placement example of the position detection coils 51, 52, 54, and 55 will be described.

In FIG. 26, (b) shows the case where the straight line connecting the center of the position detection coil 51 and the center of the position detection coil 52 and the straight line connecting the center of the position detection coil 54 and the center of the position detection coil 55 cross at the angle θ in the charger 12B. In FIG. 26, (c) shows the case where the straight line connecting the center of the position detection coil 51 and the center of the position detection coil 52 and the straight line connecting the center of the position detection coil 54 and the center of the position detection coil 55 cross at 90 degrees in the charger 12B.

When they cross at the angle θ, for example, in (b) of FIG. 26, the position detection coils are placed with a narrow spacing in a lateral direction (the position detection coils 51 and 55 and the position detection coils 54 and 52) and the position detection coils are placed with a wide spacing in a longitudinal direction (the position detection coils 51 and 54 and the position detection coils 55 and 52). In this case, a position shift in the lateral direction can be detected with higher accuracy than that in the longitudinal direction according to the magnetic flux density detected by the position detection coil. Thus, when the straight lines cross at the angle θ, a position shift in a direction in which the position detection coils are placed with a narrow spacing can be detected with higher accuracy than that in a direction in which the position detection coils are placed with a wide spacing.

On the other hand, when the straight lines cross at 90 degrees, namely, in (c) of FIG. 26, the position detection coils are placed with an equal spacing in the lateral direction and the longitudinal direction. In this case, a position shift can be detected with the same accuracy in both the lateral direction and the longitudinal direction.

Thus, to prevent the position shift detection accuracy from varying depending on the direction, it is desirable that the straight line connecting the center of the position detection coil 51 and the center of the position detection coil 52 and the straight line connecting the center of the position detection coil 54 and the center of the position detection coil 55 should cross at angle θ=90 degrees.

Next, an example of the detailed configuration to detect a position shift of the charger 12B will be described.

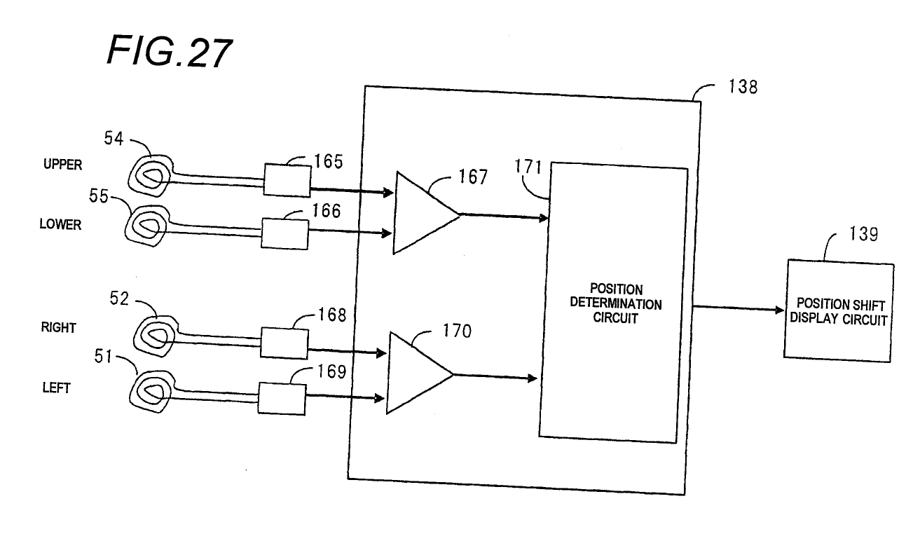

FIG. 27 shows an example of the detailed configuration to detect a position shift of the charger 12B.

The position shift detection section 138 has rectification circuits 165 and 166 for rectifying detection signals of the upper and lower position detection coils 54 and 55, a comparison circuit 167 for making a comparison between output signals of the rectification circuits 165 and 166, rectification circuits 168 and 169 for rectifying detection signals of the right and left position detection coils 51 and 52, a comparison circuit 170 for making a comparison between output signals of the rectification circuits 168 and 169, and a position determination circuit 171 for determining the position of the electronic device 11 in response to plus or minus of the output signals of the comparison circuits 167 and 170, for example.

The position shift display circuit 139 is an example of the position shift display section 139 and displays an arrow, for example, for the user so as to place the electronic device 11 at the optimum position relative to the charger 12 in response to the determination result of the position determination circuit 171. Notification may be provided for the user according to any method other than the arrow display.

Next, an example of the operation for the charger 12B to detect a position shift will be described.

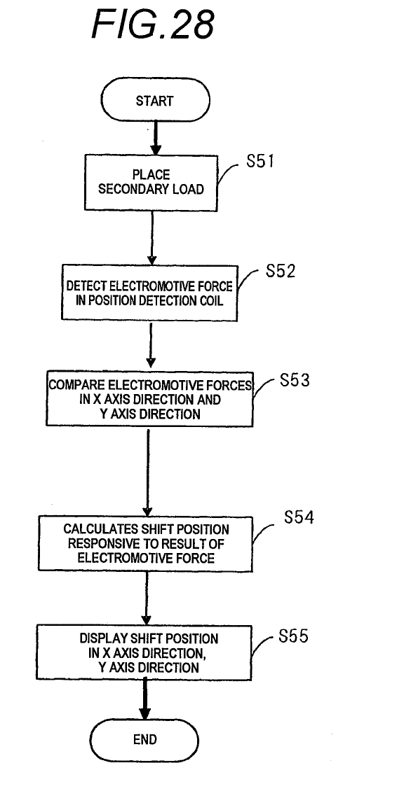

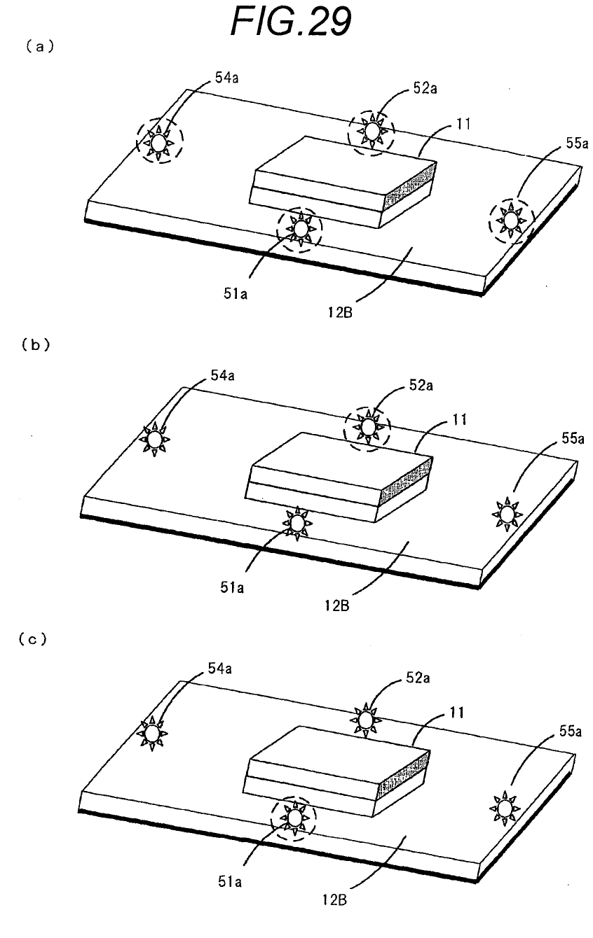

FIG. 28 is a flowchart to show an example of the operation for the charger 12B to detect a position shift. In FIG. 28, it is assumed that an X axis direction indicates a direction of the straight line connecting the first point and the second point, that a Y axis direction indicates a direction of the straight line connecting the third point and the fourth point, and that the angle between the X axis and the Y axis is the right angle.

When the electronic device 11 of secondary load is placed a predetermined position relative to the charger 12B (step S51), the position detection coils 51, 52, 54, and 55 detect an electromotive force caused by a leakage magnetic flux (step S52).

Subsequently, the comparators 167 and 170 compare electromotive forces in the X axis direction and the Y axis direction (step S53), the position determination circuit 171 calculates a shift position responsive to the result of the electromotive force (step S54), and the position shift display section 139 displays shift position in the X axis direction, the Y axis direction (step S55). Here, the shift position is information indicating which direction and how much the electronic device 11 shifts in from the normal position (see (a) of FIG. 25), for example.

Next, display examples of the position shift display section 139 will be described.

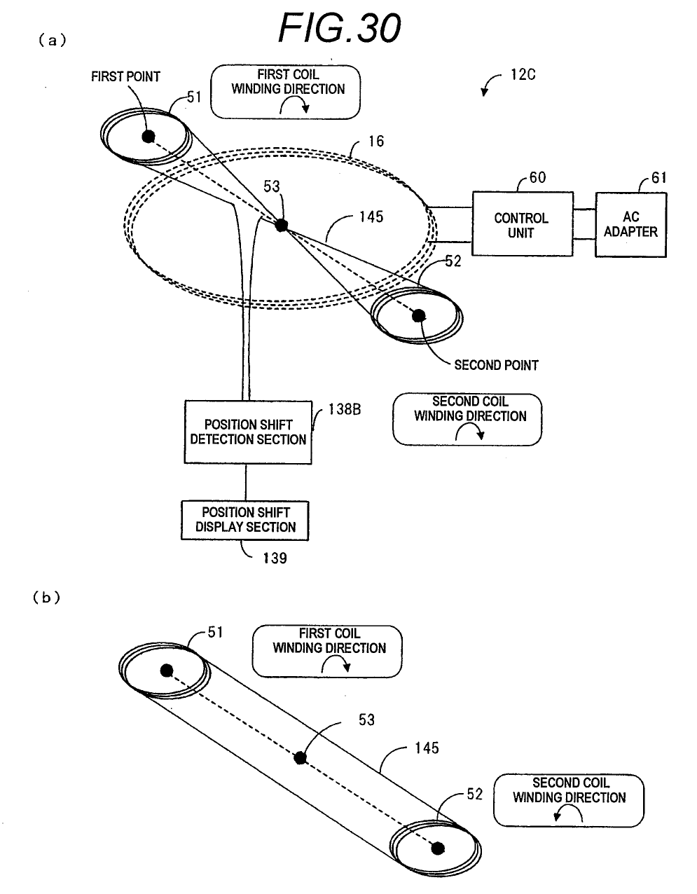

FIG. 29 shows an example of a perspective view of the charging system 100D for the position shift display section 139 to perform display. FIG. 29 shows the case where the charger 12B includes four illuminants as the position shift display section 139. FIG. 29 assumes that an illuminant 51a is placed at a position on a cabinet of the charger 12B corresponding to the position of the position detection coil 51, an illuminant 52a is placed at a position on the cabinet of the charger 12B corresponding to the position of the position detection coil 52, an illuminant 54a is placed at a position on the cabinet of the charger 12B corresponding to the position of the position detection coil 54, and an illuminant 55a is placed at a position on the cabinet of the charger 12B corresponding to the position of the position detection coil 55.

In FIG. 29, (a) shows the case where the relative position of the electronic device 11 to the charger 12B is the normal position as in (a) of FIG. 25. In this case, all illuminants 51a, 52a, 53a, and 54a emit light.

In FIG. 29, (b) shows the case where the relative position of the electronic device 11 to the charger 12B shifts in the left direction as in (b) of FIG. 25, namely, an electromotive force caused by a leakage magnetic flux occurs in the position detection coil 52. In this case, the illuminant 52a emits light.

In FIG. 29, (c) shows the case where the relative position of the electronic device 11 to the charger 12B shifts in the right direction as in (c) of FIG. 25, namely, an electromotive force caused by a leakage magnetic flux occurs in the position detection coil 51. In this case, the illuminant 51a emits light.

Here, the position shift display section 139 causes the illuminant in the opposite direction to the shift direction other than at the normal position to emit light by way of example, but an arrow may be displayed in the opposite direction to the shift direction in place of light emission. The user may be notified of a position shift by any other method if the user can recognize the shift direction.

According to the charging system 100D, if the coil position for the charger 12B to send power for charging the electronic device 11 in a non-contact manner shifts relatively to the position of the electronic device 11, it is made possible to notify the user of the optimum position to place the electronic device at the optimum position. If the electronic device 11 is at the optimum position, the user can recognize that the electronic device 11 is at the optimum position. It is made possible to place the electronic device 11 at the optimum position, so that power transmission efficiency from the charger 12B to the electronic device 11 improves and it is made possible to shorten the charging time.

### Fifth Embodiment

Next, a charging system 100E having a similar configuration to that of the charging system 100D shown in (a) of FIG. 24 will be described. The charging system 100E has an electronic device 11 and a charger 12C. A schematic view to show an example of the charging system 100E is the same as (a) of FIG. 24 except for the charger 12C rather than 12B. A drawing to show an example of the positional relationship between a primary coil 16 (main coil in the embodiment) of the charger 12C and a secondary coil 18 of the electronic device 11 is similar to FIG. 25 and therefore description is omitted.

In the embodiment, the electronic device 11 need not include a function for determining the relative position to the charger 12C.

In FIG. 30, (a) shows an example of the configuration of the charger 12C. Components identical with those of the charger 11B shown in (a) of FIG. 26 are denoted by the same reference numerals and will not be described again or will be described briefly.

The charger 12C has a primary coil 16, a control unit 60 connected to the primary coil 16 for controlling power supply, an AC adapter 61 connected to the control unit 60, a position detection coil 51 and a position detection coil 52 placed on the outer periphery of the secondary coil 16, a loop circuit 45 provided by connecting the position detection coil 51 and the position detection coil 52 placed on the outer periphery of the primary coil 16, a position shift detection section 138B connected to the loop circuit 145 for detecting a position shift, and a position shift display section 139 connected to the position shift detection section 138B for displaying a position shift for the user. Here, only two position detection coils (position detection coils 51 and 52) are shown, but four (position detection coils 51, 52, 54, and 55) may exist. The case where the number of position detection coils is four will be described below:

In the loop circuit 145, a high voltage end of the position detection coil 51 is connected to a high voltage end of the position detection coil 52 and a low voltage end of the position detection coil 51 is connected to a low voltage end of the position detection coil 52.

In the loop circuit 145, if the electromotive force caused by leakage magnetic flux of the position detection coil 51 is equal to the electromotive force caused by leakage magnetic flux of the position detection coil 52, no current flows; if the electromotive force caused by leakage magnetic flux of the position detection coil 51 differs from the electromotive force caused by leakage magnetic flux of the position detection coil 52, a current flows into the loop circuit. Accordingly, the position shift display section 139 can notify the user of information of a position shift in response to the presence or absence and the direction of the current flowing into the loop circuit.

In (a) of FIG. 30, as the loop circuit 145, a loop circuit wherein the winding directions of the position detection coil 51 and the position detection coil 52 are the same and the coils are cross-connected (8-shaped coil) is adopted, but a loop circuit of any other shape may be formed. For example, as shown in (b) of FIG. 30, as the loop circuit 145, a loop circuit wherein the winding directions of the position detection coil 51 and the position detection coil 52 are made opposite and the coils are connected as they are not crossed (non-8-shaped coil) can also be adopted.

A loop circuit 145 provided by connecting the position detection coil 54 and the position detection coil 55 has a similar configuration to that described above.

Next, an example of the detailed configuration to detect a position shift of the charger 12C will be described.

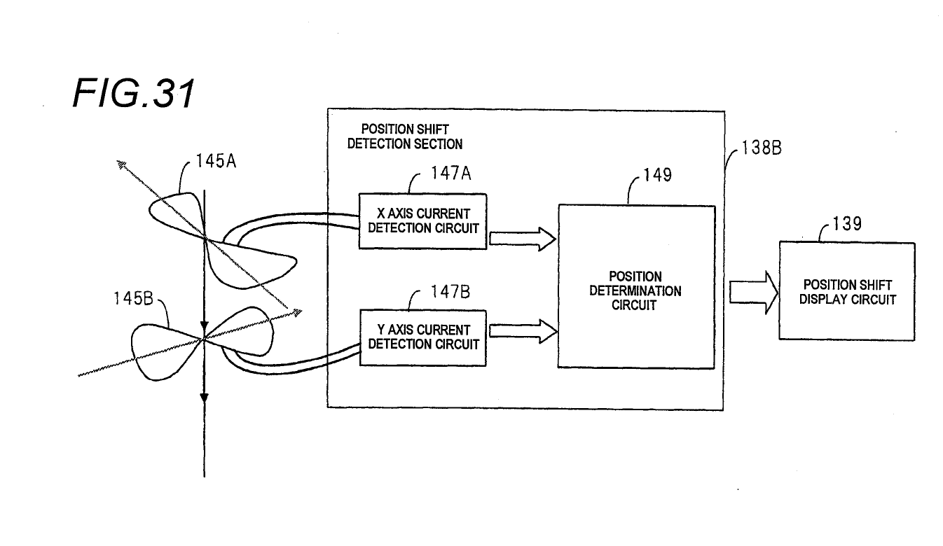

FIG. 31 shows an example of the detailed configuration to detect a position shift of the charger 12C.

The position shift detection section 138B has an X axis current detection circuit 147A, a Y axis current detection circuit 147B, and a position determination circuit 149.

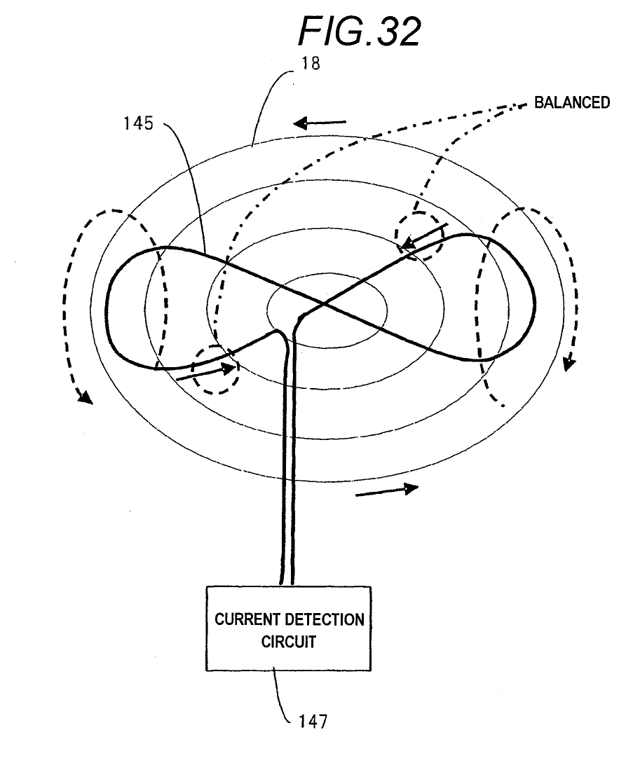

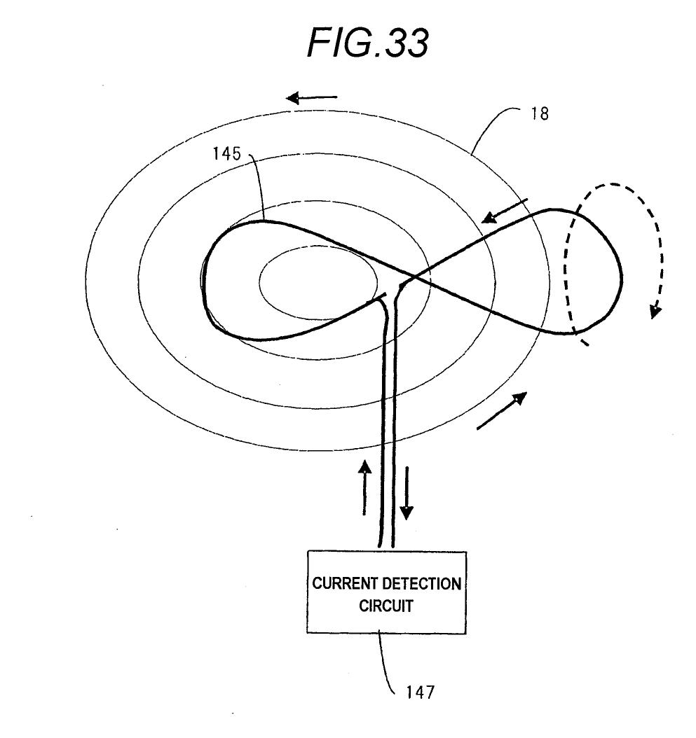

The X axis current detection circuit 147A detects a current flowing into an X axis loop circuit 145A provided by cross-connecting the position detection coil 51 and the position detection coil 52. The X axis loop circuit 145A is an example of the loop circuit 145. An example of a current detection method is shown in FIGS. 32 and 33.

The Y axis current detection circuit 147B detects a current flowing into a Y axis loop circuit 145B provided by cross-connecting the position detection coil 54 and the position detection coil 55. The Y axis loop circuit 145B is an example of the loop circuit 145. An example of a current detection method is shown in FIGS. 32 and 33.

The position determination circuit 149 is connected to the X axis detection circuit 147A and the Y axis detection circuit 147B and determines a position shift between the electronic device 11 and the charger 12C based on the currents detected in the X axis detection circuit 147A and the Y axis detection circuit 147B.

Next, an example of a current flowing through the loop circuit 145 will be described.

FIG. 32 shows an example of a current flowing through the loop circuit 145 when the relative position of the electronic device 11 to the charger 12C is appropriate. If the center of the loop circuit 145 is placed, for example, just below the center of the secondary coil 18, the magnitude of the electromotive force of the position detection coil 51 is equal to that of the position detection coil 52 and thus the current from the position detection coil 51 and the current from the position detection coil 52 cancel each other and no current flows into the loop circuit 145.

FIG. 33 shows an example of a current flowing through the loop circuit 145 when the relative position of the electronic device 11 to the charger 12C is not appropriate. If the center of the loop circuit 45 is placed, for example, at a predetermined distance or more from just below the center of the secondary coil 18, the magnitudes of the electromotive forces caused by leakage magnetic flux of the position detection coil 51 differs from that of the position detection coil 52, and thus the current from the position detection coil 51 and the current from the position detection coil 52 do not cancel each other and a current flows into the loop circuit 145. In this case, the direction of a position shift and the shift state can be determined according to the flowing direction and the magnitude of the current and the user can be requested to place the electronic device at the optimum position.

Next, an example of the operation for the charger 12C to detect a position shift will be described.

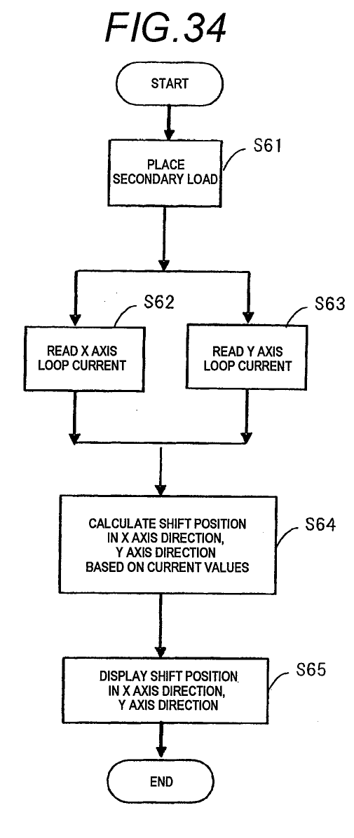

FIG. 34 is a flowchart to show an example of the operation for the charger 12C to detect a position shift. In FIG. 34, it is assumed that an X axis direction indicates a direction of the straight line connecting a first point and a second point, that a Y axis direction indicates a direction of the straight line connecting a third point and a fourth point, and that the angle between the X axis and the Y axis is the right angle.

When the electronic device 11 of secondary load is placed at a predetermined position relative to the charger 12C (step S61), the X axis current detection circuit 147A reads an X axis loop current (step S62) and the Y axis current detection circuit 147B reads a Y axis loop current (step S63).

Subsequently, the position determination circuit 149 calculates a shift position in the X axis direction, the Y axis direction based on the current values read by the X axis current detection circuit 147A and the Y axis current detection circuit 147B (step S64). The position shift display section 139 displays the shift position in the X axis direction, the Y axis direction calculated by the position determination circuit 149 (step S65).

According to the processing in FIG. 34, the position shift direction and the shift state can be determined according to the flowing direction and the magnitude of the current and an arrow can be displayed, etc., so as to place the electronic device at the optimum position. Here, four position detection coils are used to form the X axis and Y axis loops; however, the operation when only two position detection coils are included is performed considering the X axis loop only, for example.

According to the charging system 100E, if the coil position for the charger 12C to send power for charging the electronic device 11 in a non-contact manner shifts relatively to the position of the electronic device 11, it is made possible to notify the user of the optimum position to place the electronic device at the optimum position. If the electronic device 11 is at the optimum position, the user can recognize that the electronic device 11 is at the optimum position. It is made possible to place the electronic device 11 at the optimum position, so that power transmission efficiency from the charger 12 to the electronic device 11 improves and it is made possible to shorten the charging time.

Further, when the electronic device 11 is placed at the optimum position, no current flows into the loop circuit 145, so that it is made possible to decrease power consumption.

The position shift display section 139 performs display as in the display example described in the fourth embodiment, for example, (see FIG. 29).

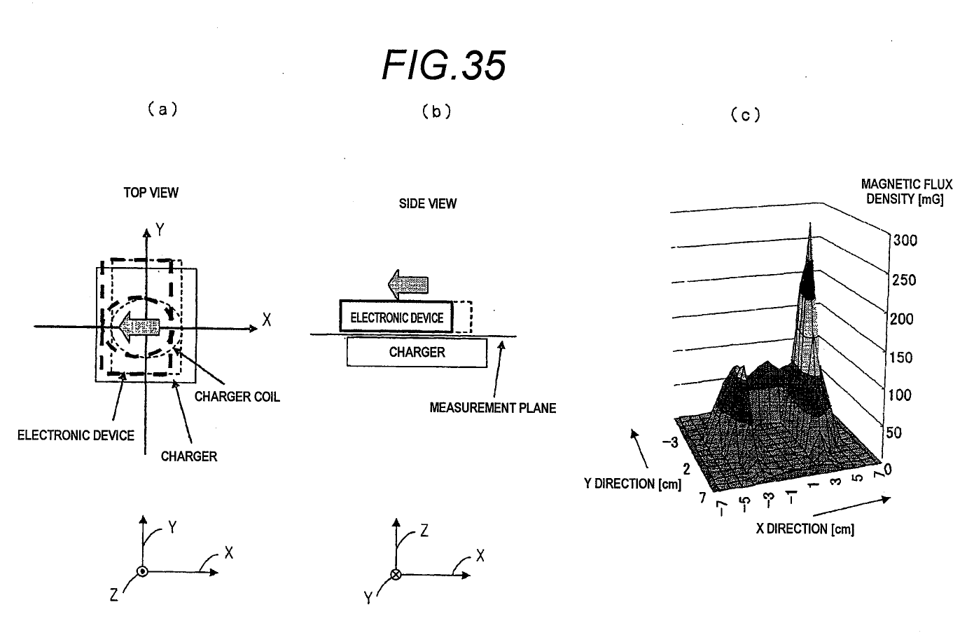

Next, an example of a magnetic field strength distribution for the charger to charge the electronic device in the fourth and fifth embodiment will be described. FIG. 35 shows an example of measurement values of a magnetic field strength distribution for the charger to charge the electronic device.

In FIG. 35, (a) is a top view of the charging system having the electronic device and the charger. In FIG. 35, (b) is a side view of the charging system. Here, the charger coil (primary coil 16) has a diameter of about 5 cm and while the electronic device was moved on the charger, a magnetic field distribution during the charging was measured with a gauss meter of a hole element (manufactured by Denshijiki Industry; GM-8501). As shown in (c) of FIG. 35, as the electronic device shifts from the center of the charger coil, the magnetic flux density on the opposite side to the shift direction becomes high and thus the user can recognize which direction the electronic device shifts in.

The present invention has been explained in detail with reference to the particular embodiments. However, it is obvious for those skilled in the art that various variations and modifications can be applied without departing from the spirit and the scope of the present invention.

This application is based upon Japanese Patent Application No. 2007-252364 filed on Sep. 27, 2007 and Japanese Patent Application No. 2007-252365 filed on Sep. 27, 2007, the contents of which are incorporated herein by reference in its entirety.

### INDUSTRIAL APPLICABILITY

The present invention is useful as an electronic device, a charging system, etc., for enabling the user to recognize the relative position of the electronic device to a power supply device. It is also useful as a charger, a charging system, etc., for enabling the user to recognize the relative position of an electronic device to the charger.

1. An electronic device using a secondary battery that can be charged by a charger for charging in a non-contact manner as a power supply, the electronic device comprising:
a main coil having a conductor wire wound around a main point for receiving power for charging the secondary battery from the charger;
a first coil placed at a first point in the electronic device, and having a conductor wire wound in a predetermined number of turns in a predetermined shape around the first point;
a second coil placed at a second point in the electronic device, the second point positioned symmetrically with respect to the first point about the main point, wherein the second coil has a conductor wire wound in the predetermined number of turns in the predetermined shape around the second point; and
a notification section, wherein
a high voltage end of the first coil is connected to a high voltage end of the second coil, and a low voltage end of the first coil is connected to a low voltage end of the second coil, whereby a loop circuit is formed,
if electromotive voltage of the first coil is equal to electromotive voltage of the second coil, no current flows into the loop circuit, and if the electromotive voltage of the first coil differs from the electromotive voltage of the second coil, a current flows into the loop circuit, and
the notification section provides notification of prompting a user to move the electronic device in response to the presence or absence and a direction of the current flowing into the loop circuit.

2. (canceled)

3. The electronic device as claimed in claim 1, further comprising:
a third coil having a conductor wire wound in the predetermined number of turns in the predetermined shape around a third point; and
a fourth coil having a conductor wire wound in the predetermined number of turns in the predetermined shape around a fourth point, wherein
the third point and the fourth point are symmetric with each other about the main point,
the loop circuit is referred to as a first loop circuit,
a high voltage end of the third coil is connected to a high voltage end of the fourth coil, and a low voltage end of the third coil is connected to a low voltage end of the fourth coil, whereby a second loop circuit is formed,
if electromotive voltage of the third coil is equal to electromotive voltage of the fourth coil, no current flows into the second loop circuit, and if the electromotive voltage of the third coil differs from the electromotive voltage of the fourth coil, a current flows into the second loop circuit,
a straight line connecting the first point and the second point and a straight line connecting the third point and the fourth point cross at a predetermined angle, and
the notification section provides the notification in response to the presence or absence and a direction of the current flowing into the second loop circuit.

4. The electronic device as claimed in claim 3, wherein the predetermined angle is substantially 90 degrees.

5. (canceled)

6. The electronic device as claimed in claim 1, wherein
the notification section includes a plurality of illuminants, and provides the notification of prompting the user to move the electronic device according to a light emission pattern of the plurality of illuminants.

7. The electronic device as claimed in claim 1, wherein
the main coil includes a flat coil placed along a predetermined plane, and
the coils are placed along the predetermined plane.

8. A charging system comprising:
a charger for charging in a non-contact manner; and
an electronic device using a secondary battery that can be charged by the charger as a power supply, wherein
the electronic device comprises:
a main coil having a conductor wire wound around a main point for receiving power for charging the secondary battery from the charger;
a first coil placed at a first point in the electronic device, and having a conductor wire wound in a predetermined number of turns in a predetermined shape around the first point;
a second coil placed at a second point in the electronic device, the second point positioned symmetrically with respect to the first point about the main point, wherein the second coil has a conductor wire wound in the predetermined number of turns in the predetermined shape around the second point; and
a notification section, wherein
a high voltage end of the first coil is connected to a high voltage end of the second coil, and a low voltage end of the first coil is connected to a low voltage end of the second coil, whereby a loop circuit is formed,
if electromotive voltage of the first coil is equal to electromotive voltage of the second coil, no current flows into the loop circuit, and if the electromotive voltage of the first coil differs from the electromotive voltage of the second coil, a current flows into the loop circuit, and
the notification section provides notification of prompting a user to move the electronic device in response to the presence or absence and a direction of the current flowing into the loop circuit.

9. A charger for charging a chargeable secondary battery used as a power supply of an electronic device in a non-contact manner, the charger comprising:
a main coil having a conductor wire wound around a main point for sending power for charging the secondary battery;
a first magnetism detection section placed at a first point in the charger;
a second magnetism detection section placed at a second point in the charger, the second point positioned symmetrically with respect to the first point about the main point; and
a notification section, wherein
if magnetic flux density detected by the first magnetism detection section is higher than magnetic flux density detected by the second magnetism detection section, the notification section provides notification of prompting a user to move the electronic device from the second point to the first point and
if the magnetic flux density detected by the second magnetism detection section is higher than the magnetic flux density detected by the first magnetism detection section, the notification section provides notification of prompting the user to move the electronic device from the first point to the second point.

10. The charger as claimed in claim 9, wherein
the first magnetism detection section is a first coil having a conductor wire wound in a predetermined number of turns in a predetermined shape around the first point,
the second magnetism detection section is a second coil having a conductor wire wound in the predetermined number of turns in the predetermined shape around the second point,
if electromotive voltage of the first coil is larger than electromotive voltage of the second coil, the notification section provides notification of prompting the user to move the electronic device from the second coil to the first coil, and wherein
if the electromotive voltage of the second coil is larger than the electromotive voltage of the first coil, the notification section provides notification of prompting the user to move the electronic device from the first coil to the second coil.

11. The charger as claimed in claim 10, further comprising:
a third coil having a conductor wire wound in the predetermined number of turns in the predetermined shape around a third point; and
a fourth coil having a conductor wire wound in the predetermined number of turns in the predetermined shape around a fourth point, wherein
the third point and the fourth point are symmetric with each other about the main point,
if electromotive voltage of the third coil is larger than electromotive voltage of the fourth coil, the notification section provides notification of prompting the user to move the electronic device from the fourth coil to the third coil, wherein
if the electromotive voltage of the fourth coil is larger than the electromotive voltage of the third coil, the notification section provides notification of prompting the user to move the electronic device from the third coil to the fourth coil, and
a straight line connecting the first point and the second point and a straight line connecting the third point and the fourth point cross at a predetermined angle.

12. The charger as claimed in claim 11 wherein the predetermined angle is substantially 90 degrees.

13. The charger as claimed in claim 10, wherein
a high voltage end of the first coil is connected to a high voltage end of the second coil, and a low voltage end of the first coil is connected to a low voltage end of the second coil, whereby a loop circuit is formed,
if the electromotive voltage of the first coil is equal to the electromotive voltage of the second coil, no current flows into the loop circuit, and if the electromotive voltage of the first coil differs from the electromotive voltage of the second coil differ, a current flows into the loop circuit, and
the notification section provides the notification of prompting in response to the presence or absence and a direction of the current flowing into the loop circuit.

14. The charger as claimed in claim 9, wherein
the notification section includes a plurality of illuminants and provides the notification of prompting the user to move the electronic device according to a light emission pattern of the plurality of illuminants.

15. The charger as claimed in claim 9, wherein
the main coil includes a flat coil placed along a predetermined plane, and
the plurality of magnetism detection sections are placed along the predetermined plane.

16. A charging system comprising:
a charger for charging in a non-contact manner; and
an electronic device using a secondary battery that can be charged by the charger as a power supply, wherein
the charger comprises:
a main coil having a conductor wire wound around a main point for sending power for charging the secondary battery;
a first magnetism detection section placed at a first point in the charger;
a second magnetism detection section placed at a second point in the charger, the second point positioned symmetrically with respect to the first point about the main point; and
a notification section, wherein
if magnetic flux density detected by the first magnetism detection section is higher than magnetic flux density detected by the second magnetism detection section, the notification section provides notification of prompting a user to move the electronic device from the second point to the first point and
if the magnetic flux density detected by the second magnetism detection section is higher than the magnetic flux density detected by the first magnetism detection section, the notification section provides notification of prompting the user to move the electronic device from the first point to the second point.
